(19) United States
(12) Patent Application Publication
(10) Pub. No.: US 2017/0305184 A1
(43) Pub. Date: Oct. 26, 2017

(54) DEVICES AND METHODS FOR ORIENTING PLATELET-SHAPED MAGNETIC OR MAGNETIZABLE PIGMENT PARTICLES

(71) Applicant: SICPA HOLDING SA, Prilly (CH)

(72) Inventor: Edgar MULLER, Lausanne (CH)

(73) Assignee: SICPA HOLDINGS SA, Prilly (CH)

(21) Appl. No.: 15/525,912

(22) PCT Filed: Nov. 20, 2015
(86) PCT No.: PCT/EP2015/077220

§ 371 Date: May 10, 2017

(30) Foreign Application Priority Data
Nov. 27, 2014 (EP) 14195159.0

(51) Int. Cl. B42D 25/369; H01F 41/16; H01F 7/02; H01F 1/03; B05D 5/06; B05D 3/00; B05D 3/06; B42D 25/41; B42D 25/378; H01F 41/24; B42D 25/29

(52) U.S. Cl. CPC B42D 25/369; H01F 41/24; H01F 41/16; H01F 7/0294; H01F 1/0306; B42D 25/29; B05D 3/207; B05D 3/067; B42D 25/41; B42D 25/378; B05D 5/065

(57) ABSTRACT

The present invention relates to the field of devices and processes for producing optical effect layers (OEL) comprising magnetically bi-axially oriented platelet-shaped magnetic or magnetizable pigment particles, in particular for producing said OELs as anti-counterfeit means on security documents or security articles or for decorative purposes. The process described herein comprises the step of a) applying on a substrate surface a radiation curable coating composition comprising platelet-shaped magnetic or magnetizable pigment particles, b) exposing the radiation curable coating composition to a dynamic magnetic field of a magnetic assembly comprising a Halbach cylinder assembly, and c) at least partially curing the radiation curable coating composition of step b) so as to fix the platelet-shaped magnetic or magnetizable pigment particles in their adopted positions and orientations, said step c) being carried out partially simultaneously or simultaneously with step b).

### FIELD OF THE INVENTION

The present invention relates to the field of processes for producing optical effect layers (OEL) comprising magnetically bi-axially oriented platelet-shaped magnetic or magnetizable pigment particles. In particular, the present invention provides devices and processes for producing said OELs as anti-counterfeit means on security documents or security articles or for decorative purposes.

### BACKGROUND OF THE INVENTION

The use of inks, coating compositions, coatings, or layers, containing magnetic or magnetizable pigment particles, in particular platelet-shaped optically variable magnetic or magnetizable pigment particles, for the production of security elements and security documents is known in the art.

Security features, e.g. for security documents, can be classified into “covert” and “overt” security features. The protection provided by covert security features relies on the concept that such features are hidden, typically requiring specialized equipment and knowledge for their detection, whereas “overt” security features are easily detectable with the unaided human senses, e.g. such features may be visible and/or detectable via the tactile senses while still being difficult to produce and/or to copy. However, the effectiveness of overt security features depends to a great extent on their easy recognition as a security feature, because users will only then actually perform a security check based on such security feature if they are aware of its existence and nature.

Coatings or layers comprising oriented magnetic or magnetizable pigment particles are disclosed for example in U.S. Pat. No. 2,570,856; U.S. Pat. No. 3,676,273; U.S. Pat. No. 3,791,864; U.S. Pat. No. 5,630,877 and U.S. Pat. No. 5,364,689. Magnetic or magnetizable pigment particles in coatings allow for the production of magnetically induced images, designs and/or patterns through the application of a corresponding magnetic field, causing a local orientation of the magnetic or magnetizable pigment particles in the unhardened coating, followed by hardening the latter. This results in specific optical effects, i.e. fixed magnetically induced images, designs or patterns which are highly resistant to counterfeit. The security elements based on oriented magnetic or magnetizable pigments particles can only be produced by having access to both the magnetic or magnetizable pigment particles or a corresponding ink or composition comprising said particles, and the particular technology employed to apply said ink or composition and to orient said pigments in the applied ink or composition.

For example, U.S. Pat. No. 7,047,883 discloses an apparatus and a method for producing optical effect layers (OEL's), obtained by orienting magnetic or magnetizable optically variable pigment flakes in a coating composition; the disclosed apparatus consists in specific arrangements of permanent magnets placed under the substrate carrying said coating composition. According to U.S. Pat. No. 7,047,883, a first portion of the magnetic or magnetizable optically variable pigment flakes in the OEL is oriented such as to reflect light in a first direction and a second portion adjacent to the first one is aligned such as to reflect light in a second direction, producing a visual “flip-flop” effect upon tilting the OEL.

WO 2006/069218 A2 discloses a substrate comprising an OEL comprising optically variable magnetic or magnetizable pigment flakes, oriented in such a way that a bar appears to move when said OEL is tilted (“rolling bar”). According to WO 2006/069218 A2, specific arrangements of permanent magnets under the substrate carrying the optically variable magnetic or magnetizable pigment flakes serve to orient said flakes such as to imitate a curved surface.

U.S. Pat. No. 7,955,695 relates to an OEL wherein so-called grated magnetic or magnetizable pigment particles are oriented mainly vertical to the substrate surface, such as to produce visual effects imitating a butterfly's wing with strong interference colors. Here again, specific arrangements of permanent magnets under the substrate carrying the coating composition serve to orient the pigment particles.

EP 1 819 525 B1 discloses a security element having OEL which appears transparent at certain angles of view, thus giving visual access to underlying information, whilst staying opaque at other viewing angles. To obtain this effect, known as “Venetian blind effect”, specific arrangements of permanent magnets under the substrate orient the optically variable magnetizable or magnetic pigment flakes at a predetermined angle relatively to the substrate surface.

For certain applications, a homogeneous orientation of platelet-shaped magnetic or magnetizable pigment particles parallel to the substrate surface is required. Such “planar orientation” or “planarization” has been disclosed for various technical fields, such as the production of recording media to store acoustic or optical data (U.S. Pat. No. 2,711,911, U.S. Pat. No. 2,796,359, U.S. Pat. No. 3,001,891, U.S. Pat. No. 3,222,205, and U.S. Pat. No. 4,672,913), the production of absorbing paints for shielding electromagnetic waves (U.S. Pat. No. 2,951,246, U.S. Pat. No. 2,996,709, and U.S. Pat. No. 6,063,511), the production of decorative coatings and layers (U.S. Pat. No. 2,418,479, U.S. Pat. No. 2,570,856, U.S. Pat. No. 3,095,349, and U.S. Pat. No. 5,630,877), as well as for security documents (U.S. Pat. No. 8,137,762 and U.S. Pat. No. 7,258,900).

U.S. Pat. No. 4,672,913 discloses a method and an apparatus for making a magnetic recording medium containing ferromagnetic particles. The disclosed apparatus comprises rod-like permanent magnets disposed at oblique angles with respect to each other, positioned under the moving substrate carrying the coating composition containing said ferromagnetic particles. The permanent magnets are magnetized perpendicular to the substrate surface. Under the influence of the magnet field of the permanent magnets and the movement of the substrate carrying the coating composition along said magnets, the ferromagnetic particles align substantially parallel to the substrate surface. The so-obtained recording medium shows improved performance.

U.S. Pat. No. 6,063,511 discloses a device, and a method of making said device, for absorbing electromagnetic radiation in a predetermined frequency range. The device comprises a coating composition comprising ferrite flakes on a substrate, said flakes being aligned, by a simple evaporation or by the influence of a magnetic field, such that the plane of the flakes is substantially parallel to the substrate surface.

U.S. Pat. No. 5,630,877 discloses a method and an apparatus for producing a painted product, having a magnetically formed pattern thereon, the method serving to form any desirable pattern in diversely different shapes. The painted product is obtained by applying a coating layer onto a substrate, using a coating composition comprising non-spherical magnetic particles that are aligned using a magnetic field produced by permanent magnets and/or electromagnets. U.S. Pat. No. 5,630,877 further teaches that the magnetic field has a first region of field lines which are substantially parallel to the surface of the coated product, and a second region of field lines which are substantially non-parallel to the surface of the coated product.

U.S. Pat. No. 7,258,900 discloses a method for planarizing magnetic pigment flakes, said method comprising the steps of applying magnetic pigment flakes to a surface of a substrate, and applying a magnetic field to align at least part of the magnetic pigment flakes in a plane parallel to the surface of the substrate. Permanent magnets are disposed on each side of the substrate surface or below it, such that the magnetic field lines are substantially parallel to the substrate surface.

U.S. Pat. No. 8,137,762 discloses a method for planarizing (two-axial alignment of) a plurality of orientable non-spherical magnetic or magnetizable flakes in a coating composition on a longitudinal web. The web supporting the coating composition comprising the flakes is running between permanent magnets, such that the magnetic field of the permanent magnets traverses the web. First and third magnets are provided on one side of the web and a second magnet is provided between the first and second magnets on the opposite side of the web, i.e. the magnets are disposed in a staggered configuration. When the web is moving, the flakes experience a first rotation as they pass through the magnetic field between the first and the second permanent magnets, and a second rotation when they pass through the magnetic field between the second and third permanent magnets, and align in this way substantially parallel to the substrate surface.

The methods disclosed in U.S. Pat. No. 7,258,900 and U.S. Pat. No. 8,137,762 have both the inconvenient that the magnetic fields produced by the described arrangements of permanent magnets are substantially parallel to the substrate surface over a limited area only, making these methods unsuitable for use on a wide web in an industrial printing process. Furthermore, they suffer from a lack of freedom for choosing the elevation angle between the substrate surface and the alignment plane of the magnetic pigment flakes; in other words, only a 0° angle between the plane of magnetic pigment flakes and the substrate may be carried out.

The production of an OEL comprising platelet-shaped magnetic or magnetizable pigment particles having a bi-axial homogeneous orientation substantially parallel to the substrate surface, or at a predetermined elevation angle with respect to the substrate surface over a wide web in a large-scale, industrial printing process is thus not trivial.

Upon exposure to an external magnetic field H, platelet-shaped magnetic or magnetizable pigment particles tend to align their longest dimension, i.e. a first of its two in-plane dimensions, with the magnetic field lines of H, as shown in FIG. 1A. This results in a so-called mono-axial orientation of said pigment particles. This is the orientation state of minimal energy of said pigment particles in the magnetic field H. However, the second of the in-plane dimensions of a platelet-shaped magnetic or magnetizable pigment particle may still have any arbitrary direction orthogonal to the field line of H. A platelet-shaped magnetic or magnetizable pigment particle may in fact rotate around a field line of H without losing its state of minimal energy.

In the case OELs comprising magnetically oriented platelet-shaped optically variable magnetic or magnetizable pigment particles, the visual appearance of said OELs strongly depends on the viewing angle with respect to their surface, as given by said first and second in-plane dimensions. The visual appearance is for example expressed as lightness (L*), chroma (c*) and hue (h*) in the CIE La*b* color system. Hence, a bi-axial orientation, i.e. a control of the particle orientation in both in-plane dimensions is required in order to produce a desired color effect and maximal reflectivity. Such a bi-axial orientation cannot be achieved by the sole application of magnetic fields, but requires the cooperation of magnetic forces with additional mechanical means, like the movement of the substrate or web carrying the coating composition as disclosed in U.S. Pat. No. 8,137,762.

Thus, there remains a need for a device and a process for producing optical effect layers (OEL's) comprising bi-axially oriented platelet-shaped magnetic or magnetizable pigment particles, in particular platelet-shaped optically variable magnetic or magnetizable pigment particles, having a homogeneous orientation substantially parallel to the substrate surface, or at a predetermined elevation angle with respect to the substrate surface, over a wide web or sheets in a large-scale, industrial printing process.

### SUMMARY OF THE INVENTION

Accordingly, it is an object of the present invention to overcome the deficiencies of the prior art as discussed above. This is achieved by the provision of taking advantage of a Halbach cylinder for generating a transversal homogeneous magnetic dipole field (for “Halbach arrays”, “Halbach cylinders”: see K. Halbach (1980). “Design of permanent multipole magnets with oriented rare earth cobalt material”. Nuclear Instruments and Methods 169 (1): 1-10).

Described herein are processes for producing an optical effect layer (OEL) on a substrate, said process comprising the steps of:
a) applying on a substrate surface a radiation curable coating composition comprising i) platelet-shaped magnetic or magnetizable pigment particles and ii) a binder, said radiation curable composition being in a first state,
b) exposing the radiation curable coating composition to a dynamic magnetic field of a magnetic assembly comprising a Halbach cylinder assembly comprising either i) three or more magnet bars and a single magnet-wire coil surrounding said assembly, or ii) three or more magnet bars, a pole piece encompassing said assembly and comprising two poles facing said assembly, each pole being surrounded by a magnet-wire coil, or iii) three or more structures, each of said three or more structures comprising a magnet bar and a magnet-wire coil surrounding said magnet bar, so as to bi-axially orient at least a part of the platelet-shaped magnetic or magnetizable pigment particles, said at least three magnet bars being transversally magnetized, and
c) at least partially curing the radiation curable coating composition of step b) to a second state so as to fix the platelet-shaped magnetic or magnetizable pigment particles in their adopted positions and orientations, said step c) being carried out partially simultaneously or simultaneously with step b).

According to a preferred embodiment, step b) is carried out so as to bi-axially orient at least a part of the platelet-shaped magnetic or magnetizable pigment particles to i) have their major and minor axes substantially parallel to the substrate surface, or ii) have their major axis at a substantially non-zero elevation angle to the substrate surface and their minor axis substantially parallel to the substrate surface.

Also described herein are OELs produced by the process described herein and security documents as well as decorative elements or objects comprising one or more optical OELs described herein

Also described herein are devices for producing an optical effect layer (OEL) on a substrate such as those described herein, said OEL comprising platelet-shaped magnetic or magnetizable pigment particles being bi-axially oriented in a cured radiation curable coating composition such as described herein, the device comprising a) the Halbach cylinder assembly described herein and a curing unit.

The device may be defined to further include means for applying an AC current of appropriate amplitude and frequency to the magnet-wire coil(s) so that the dynamic magnetic field results from a magnetic dipole field (H_{xy}) inside the Halbach cylinder assembly and a dynamic-component (H_{z}) obtained by applying the AC current.

In an embodiment, the Halbach cylinder assembly is configured for exposing a radiation curable coating composition comprising platelet-shaped magnetic or magnetizable pigment particles coated on the substrate to a dynamic magnetic field of a magnetic assembly comprising the Halbach cylinder assembly so as to bi-axially orient at least a part of the platelet-shaped magnetic or magnetizable pigment particles. The curing unit is configured for at least partially curing the radiation curable coating composition so as to fix the platelet-shaped magnetic or magnetizable pigment particles in their adopted positions and orientations simultaneously or partially simultaneously with exposing the magnetic or magnetizable pigment particles with the dynamic magnetic field of the Halbach cylinder assembly.

Also disclosed is a device for producing an optical effect layer (OEL) on a substrate, said OEL comprising platelet-shaped magnetic or magnetizable pigment particles being oriented in a cured radiation curable coating composition, the device comprising:
a) a Halbach cylinder assembly so as to bi-axially orient at least a part of the platelet-shaped magnetic or magnetizable pigment particles, and
b) a curing unit.

The Halbach cylinder assembly comprises one or magnetic-wire coils so that when an AC current of suitable amplitude and frequency is applied thereto a dynamic magnetic field results from a magnetic dipole field (H_{xy}) inside the Halbach cylinder assembly and a dynamic-component (H_{z}) obtained by applying the AC current.

The Halbach cylinder assembly is configured for producing the dynamic magnetic field in its interior. The Halbach cylinder assembly is sufficiently open on the sides so that there is enough space to allow the substrate to pass into and out of the interior of the Halbach cylinder assembly.

The device comprises substrate guiding or supporting means for supporting the substrate within the Halbach cylinder for exposure to the dynamic magnetic field of the Halbach cylinder.

The curing unit may be located in an interior of the Halbach cylinder assembly.

The curing unit may be positioned in a border part of a region of the Halbach cylinder assembly opposite to a side wherein the substrate enters the Halbach cylinder assembly.

The device may comprise an application unit, e.g. a printing unit, for applying on a substrate surface a radiation curable coating composition comprising i) platelet-shaped magnetic or magnetizable pigment particles and ii) a binder.

The Halbach cylinder assembly described herein can be easily integrated into large-size, industrial printing and magnetic orienting devices used for the production of security documents, in particular banknotes, or decorative elements or objects comprising one or more security features or optical effect layers based on bi-axially oriented platelet-shaped magnetic or magnetizable pigment particles. Indeed, the homogeneous magnetic dipole field generated by said assembly is not limited in its width, i.e. increasing the length of the magnet bars of the Halbach cylinder assembly increases the surface covered by said homogeneous magnetic dipole field. Therefore, the process described herein allows producing optical effect layers based on bi-axially orientated platelet-shaped magnetic or magnetizable pigment particles in an efficient way and at a low cost.

Moreover and contrary to the processes described in the prior at, the process described herein allows the substrate carrying the coating composition to be conveyed to the Halbach cylinder assembly described herein either in a continuous or in a discontinuous way, since no relative movement between the platelet-shaped magnetic or magnetizable pigment particles dispersed within the coating composition and the assembly is required. This greatly enhances the versatility and freedom of the process for producing OELs, said process may be implemented as easily in industrial-scale, high-productivity continuous processes, as in lower productivity, discontinuous processes.

Furthermore, the angle between the X-Y plane of the platelet-shaped magnetic or magnetizable pigment particles and the substrate surface may be easily set at a desired value, depending on the visual effect to obtain, by a concerted, in-place rotation of the individual magnet bars making up the Halbach cylinder assembly. This is in contrary to the prior art wherein the design of the magnetic orienting means is fixed, also resulting in a fixed angle (e.g. 0° or 90°) between the X-Y plane of the platelet-shaped pigment particles of the coating composition and the substrate surface. Accordingly, a complete re-design of the fixed orientation means has to be carried out in order to modify said angle.

### BRIEF DESCRIPTION OF DRAWINGS

FIG. 1A schematically depicts the alignment of platelet-shaped magnetic or magnetizable pigment particles in a magnetic field H; only a single axis is aligned.

FIG. 1B schematically illustrates a platelet-shaped pigment particle.

FIG. 2A-D illustrate conventional Halbach cylinders for generating a magnetic dipole field H_{xy}, consisting of three, four, six and eight transversally magnetized, equal magnet bars. The individual magnet bars (1-6) are indicated for FIG. 2C

FIG. 3 illustrates the rotation of a magnetic dipole field H_{xy} of a Halbach cylinder through a concerted, in-place rotation of the individual magnet bars making up the Halbach cylinder.

FIG. 4A graphically shows the magnetic dipole field H_{xy}, generated by the Halbach assembly and making an elevation angle α with the substrate surface (x-axis). The dynamic magnetic field component H_{z}, perpendicular to H_{xy}, also lies in the P(u,v) plane. The coordinate-system is indicated by reference (only x and y are visible).

FIG. 4B is obtained by rotating FIG. 4A around y by 90°. Now, the dynamic magnetic field H_{z} component is visible, H_{z} and H_{z}′ corresponding to the projection onto the v=z axis of the total magnetic dipole field H, H′ at an angle β, β′ (β=β′) with the substrate surface (z-axis). The coordinate-system is indicated by reference (only y and z are visible).

FIG. 5A schematically depicts the addition of a field component H_{z} orthogonal to the magnetic dipole field H_{xy}, by virtue of a magnet-wire coil (7a) surrounding a Halbach cylinder assembly (9) comprising eight transversally magnetized, equal magnet bars (8).

FIG. 5B schematically depicts the addition of a field component H_{z} orthogonal to the magnetic field H_{xy}, by virtue of a pole piece (10a) encompassing the Halbach cylinder assembly (9), said pole piece (10a) having two poles, each pole being surrounded by an axial magnet-wire coil (7b-1, 7b-2).

FIG. 6 schematically depicts a cross-section through the Halbach cylinder assembly (9), wherein the field component H_{z} is generated by virtue of individual magnet-wire coils (7c) surrounding each of the magnet bars (8) conjointly producing the magnetic dipole field H_{xy}. The substrate (11) carrying the radiation curable coating composition (12) is also indicated.

FIG. 7 schematically depicts the construction of an extended composite magnet bar comprising a plurality of split magnets (13-1, 13-2), each comprising a magnet bar and two pole pieces (10b-1, 10b-2), as detailed for the split magnet 13-1, and kept together by a two-part holder (15-1, 15-2). Gaps (14) are present between the split magnets (13-1, 13-2) to accommodate non-magnetic fixing elements (not shown).

FIG. 8 more precisely depicts the Halbach cylinder assembly (9), each magnet bar (8) comprising two pole pieces (10b-1, 10b-2) and being surrounded by a magnet-wire coil (7c). A curing unit (16) is disposed above the substrate (11) carrying the radiation curable coating composition (12). Rollers (17) to support said substrate (11) are also indicated.

FIG. 9A schematically depicts a structure comprising a transversally magnetized magnet bar (8), having two pole pieces made of low-coercivity, high-saturation magnetic material (10b-1, 10b-2), the structure being surrounded by a magnet wire coil (7c) of appropriate electrical dimension.

FIG. 9B schematically depicts a composite magnet-wire coil with windings (7c′, 7c″, 7c″″) in parallel.

FIG. 10 schematically depicts another embodiment of the Halbach cylinder assembly (9), wherein the curing unit (16) is disposed on the other side of the substrate (11), the curing of the radiation curable coating composition (12) taking place through said substrate (11).

FIG. 11A schematically depicts an embodiment of the Halbach cylinder assembly (9), wherein a fixed screen photomask (18a) is placed between the curing unit (16) and the substrate (11) carrying the radiation curable coating composition (12).

FIG. 11B schematically depicts an embodiment of the Halbach cylinder assembly (9), wherein a mobile screen photomask (18b) is placed between the curing unit (16) and the substrate (11) carrying the radiation curable coating composition (12).

FIG. 110 schematically depicts an embodiment of the Halbach cylinder assembly (9), wherein a mobile screen photomask (18b) is placed on the other side of the substrate (11) carrying the radiation curable coating composition (12) and wherein the curing unit (16) is placed on the other side of said substrate (11), said curing unit (16) curing the radiation curable coating composition (12) through said substrate (11).

FIG. 12A-12B show the magnetic field distributions: FIG. 12A in a section through a Halbach cylinder assembly according to FIG. 6, comprising four structures, each one comprising a magnet bar surrounded by a magnet-wire coil, and FIG. 12B in a section through Halbach cylinder assembly comprising eight structures, each one comprising a magnet bar surrounded by a magnet-wire coil.

FIG. 13 shows a CAD drawing of the Halbach cylinder assembly exemplified in FIG. 6.

FIG. 14A-14C shows telecentric microscopic images of an optically variable radiation curable coating composition in a: FIG. 14A random state, FIG. 14B mono-axially oriented state and FIG. 14C bi-axially oriented state.

### DETAILED DESCRIPTION

### Definitions

The following definitions clarify the meaning of the terms used in the description and in the claims.

As used herein, the indefinite article “a” indicates one as well as more than one and does not necessarily limit its referent noun to the singular.

As used herein, the term “about” means that the amount, value or limit in question may be the specific value designated or some other value in its neighborhood. Generally, the term “about” denoting a certain value is intended to denote a range within ±5% of the value. For example, the phrase “about 100” denotes a range of 100±5, i.e. the range from 95 to 105. Generally, when the term “about” is used, it can be expected that similar results or effects according to the invention can be obtained within a range of ±5% of the indicated value. However, a specific amount, value or limit supplemented with the term “about” is intended herein to disclose as well the very amount, value or limit as such, i.e. without the “about” supplement.

As used herein, the term “and/or” means that either all or only one of the elements of said group may be present. For example, “A and/or B” shall mean “only A, or only B, or both A and B”. In the case of “only A”, the term also covers the possibility that B is absent, i.e. “only A, but not B”.

The term “comprising” as used herein is intended to be non-exclusive and open-ended. Thus, for instance a radiation curable coating composition comprising a compound A may include other compounds besides A. However, the term “comprising” also covers, as a particular embodiment thereof, the more restrictive meanings of “consisting essentially of” and “consisting of”, so that for instance “a radiation curable coating composition comprising a compound A” may also (essentially) consist of the compound A.

As used herein, the term “wet” refers to an applied coating, which is not yet cured, for example a coating in which the platelet-shaped magnetic or magnetizable pigment particles are still able to change their positions and orientations under the influence of external forces acting upon them.

The term “radiation curable coating composition” refers to any composition which is capable of forming a coating, such as an optical effect layer on a solid substrate, which can be applied and which can be cured upon exposure to irradiation, i.e. an electromagnetic radiation (radiation curing).

The term “optical effect layer (OEL)” as used herein denotes a coating or layer that comprises oriented platelet-shaped magnetic or magnetizable pigment particles and a binder, wherein said platelet-shaped magnetic or magnetizable pigment particles are oriented by a magnetic field and wherein the oriented platelet-shaped magnetic or magnetizable pigment particles are frozen in their orientation and position (i.e. after curing).

The term “magnetic axis” or “South-North axis” denotes a theoretical line connecting the South and the North pole of a magnet and extending through them. These terms do not include any specific direction. Conversely, the term “South-North direction” and S→N on the figures denote the direction along the magnetic axis from the South pole to the North pole.

The term “substantially parallel” refers to deviating not more than 20° from parallel alignment and the term “substantially perpendicular” refers to deviating not more than 20° from perpendicular alignment.

The term “substantially orthogonal” refers to an axis, a vector or a line which does not deviate more than 20° from being orthogonal to a plane.

The term “pole piece” denotes a structure composed of a magnetic material having a low coercivity and high saturation, said pole piece serving to direct and intensify the magnetic field produced by a permanent magnet or an electromagnet.

The term “security element” or “security feature” is used to denote an image or graphic element that can be used for authentication purposes. The security element or security feature can be overt and/or covert.

Embodiments of the invention will now be described with reference to the enclosed drawings. The foregoing descriptions of specific embodiments of the present invention have been presented for purposes of illustration and description. They are not intended to be exhaustive or to limit the present invention to the precise forms disclosed, and obviously many modifications and variations are possible in light of the above teaching. The exemplary embodiments were chosen and described in order to best explain the principles of the present invention and its practical application, to thereby enable others skilled in the art to best utilize the present invention and various embodiments with various modifications as are suited to the particular use contemplated.

The methods for producing an OEL on the substrate described herein comprises a step of applying on the substrate surface a radiation curable coating composition comprising i) platelet-shaped magnetic or magnetizable pigment particles and ii) a binder material, said radiation curable coating composition being in a first state. The applying step a) described herein is preferably carried out by a printing process preferably selected from the group consisting of screen printing, rotogravure printing, flexography printing, inkjet printing and intaglio printing (also referred in the art as engraved copper plate printing and engraved steel die printing), more preferably selected from the group consisting of screen printing, rotogravure printing and flexography printing. These processes are well-known to the skilled man and are described for example in Printing Technology, J. M. Adams and P. A. Dolin, Delmar Thomson Learning, 5^{th} Edition.

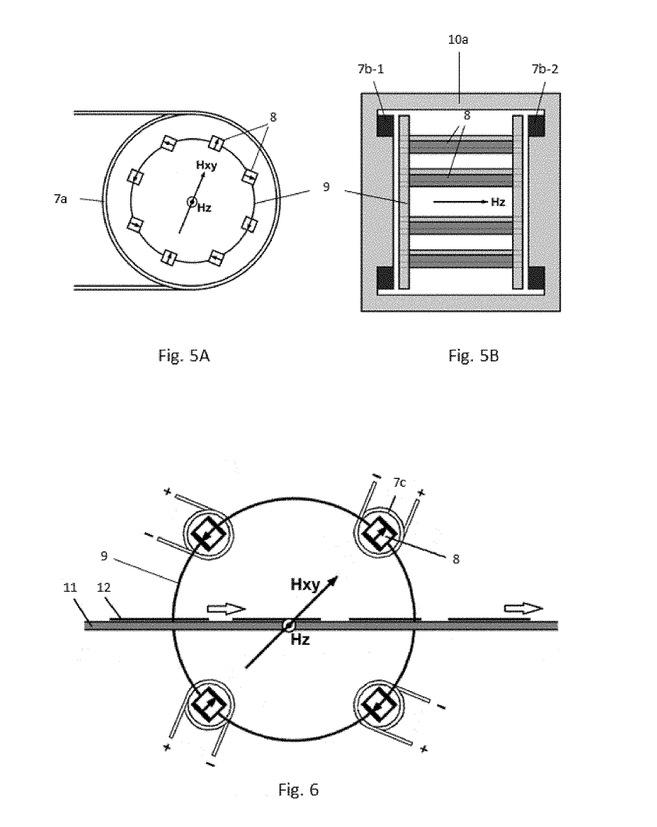

Subsequently to, partially simultaneously with or simultaneously with the application of the radiation curable coating composition described herein on the substrate surface described herein, at least a part of the platelet-shaped magnetic or magnetizable pigment particles are bi-axially oriented by exposing the radiation curable coating composition to the dynamic (i.e. oscillating, time dependent, time-varying or time-variable) magnetic field of a magnetic assembly comprising a Halbach cylinder assembly comprising either i) three or more magnet bars and a single magnet-wire coil surrounding said assembly (see for example FIG. 5A), or ii) three or more magnet bars, a pole piece encompassing said assembly and comprising two poles facing said assembly, each pole being surrounded by a magnet-wire coil (see for example FIG. 5B) or iii) three or more structures, each of these three or more structures comprising a magnet bar and a magnet-wire coil surrounding said magnet bar, so as to align at least part of the platelet-shaped magnetic or magnetizable pigment particles along the magnetic field lines generated by the Halbach cylinder assembly. Partially simultaneously or simultaneously with the steps of orienting/aligning at least a part of the platelet-shaped magnetic or magnetizable pigment particles by applying the dynamic magnetic field described herein, the orientation of the platelet-shaped magnetic or magnetizable pigment particles is fixed or frozen. The radiation curable coating composition must thus noteworthy have a first state, i.e. a liquid or pasty state, wherein the radiation curable coating composition is wet or soft enough, so that the platelet-shaped magnetic or magnetizable pigment particles dispersed in the radiation curable coating composition are freely movable, rotatable and/or orientable upon exposure to the dynamic magnetic field, and a second cured (e.g. solid) state, wherein the platelet-shaped magnetic or magnetizable pigment particles are fixed or frozen in their respective positions and orientations.

Such a first and second state is provided by using a certain type of radiation curable coating composition. For example, the components of the radiation curable coating composition other than the platelet-shaped magnetic or magnetizable pigment particles may take the form of an ink or radiation curable coating composition such as those which are used in security applications, e.g. for banknote printing. The aforementioned first and second states are provided by using a material that shows an increase in viscosity in reaction to an exposure to an electromagnetic radiation. That is, when the fluid binder material is cured or solidified, said binder material converts into the second state, i.e. a cured or solid state, where the platelet-shaped magnetic or magnetizable pigment particles are fixed in their current positions and orientations and can no longer move nor rotate within the binder material.

As known to those skilled in the art, ingredients comprised in a radiation curable coating composition to be applied onto a surface such as a substrate and the physical properties of said radiation curable coating composition must fulfil the requirements of the process used to transfer the radiation curable coating composition to the substrate surface. Consequently, the binder material comprised in the radiation curable coating composition described herein is typically chosen among those known in the art and depends on the coating or printing process used to apply the radiation curable coating composition and the chosen radiation curing process.

In the OELs described herein, the platelet-shaped magnetic or magnetizable pigment particles described herein are dispersed in the radiation curable coating composition comprising a cured binder material that fixes/freezes the orientation of the platelet-shaped magnetic or magnetizable pigment particles. The cured binder material is at least partially transparent to electromagnetic radiation of a range of wavelengths comprised between 200 nm and 2500 nm. The binder material is thus, at least in its cured or solid state (also referred to as second state herein), at least partially transparent to electromagnetic radiation of a range of wavelengths comprised between 200 nm and 2500 nm, i.e. within the wavelength range which is typically referred to as the “optical spectrum” and which comprises infrared, visible and UV portions of the electromagnetic spectrum, such that the particles contained in the binder material in its cured or solid state and their orientation-dependent reflectivity can be perceived through the binder material. Preferably, the cured binder material is at least partially transparent to electromagnetic radiation of a range of wavelengths comprised between 200 nm and 800 nm, more preferably comprised between 400 nm and 700 nm. Herein, the term “transparent” denotes that the transmission of electromagnetic radiation through a layer of 20 μm of the cured binder material as present in the OEL (not including the platelet-shaped magnetic or magnetizable pigment particles, but all other optional components of the OEL in case such components are present) is at least 50%, more preferably at least 60%, even more preferably at least 70%, at the wavelength(s) concerned. This can be determined for example by measuring the transmittance of a test piece of the cured binder material (not including the platelet-shaped magnetic or magnetizable pigment particles) in accordance with well-established test methods, e.g. DIN 5036-3 (1979-11). If the OEL serves as a covert security feature, then typically technical means will be necessary to detect the (complete) optical effect generated by the OEL under respective illuminating conditions comprising the selected non-visible wavelength; said detection requiring that the wavelength of incident radiation is selected outside the visible range, e.g. in the near UV-range. In this case, it is preferable that the OEL comprises luminescent pigment particles that show luminescence in response to the selected wavelength outside the visible spectrum contained in the incident radiation. The infrared, visible and UV portions of the electromagnetic spectrum approximately correspond to the wavelength ranges between 700-2500 nm, 400-700 nm, and 200-400 nm respectively.

As mentioned hereabove, the radiation curable coating composition described herein depends on the coating or printing process used to apply said radiation curable coating composition and the chosen curing process. Preferably, curing of the radiation curable coating composition involves a chemical reaction which is not reversed by a simple temperature increase (e.g. up to 80° C.) that may occur during a typical use of an article comprising the OEL described herein. The term “curing” or “curable” refers to processes including the chemical reaction, crosslinking or polymerization of at least one component in the applied radiation curable coating composition in such a manner that it turns into a polymeric material having a greater molecular weight than the starting substances. Radiation curing advantageously leads to an instantaneous increase in viscosity of the radiation curable coating composition after exposure to the curing irradiation, thus preventing any further movement of the pigment particles and in consequence any loss of information after the magnetic orientation step. Preferably, the curing step (step c)) is carried out by radiation curing including UV-visible light radiation curing or by E-beam radiation curing, more preferably by UV-Vis light radiation curing.

Therefore, suitable radiation curable coating compositions for the present invention include radiation curable compositions that may be cured by UV-visible light radiation (hereafter referred as UV-Vis radiation curable) or by E-beam radiation (hereafter referred as EB). Radiation curable compositions are known in the art and can be found in standard textbooks such as the series “Chemistry & Technology of UV & EB Formulation for Coatings, Inks & Paints”, Volume IV, Formulation, by C. Lowe, G. Webster, S. Kessel and I. McDonald, 1996 by John Wiley & Sons in association with SITA Technology Limited. According to one particularly preferred embodiment of the present invention, the radiation curable coating composition described herein is a UV-Vis radiation curable coating composition.

Preferably, the UV-Vis radiation curable coating composition comprises one or more compounds selected from the group consisting of radically curable compounds and cationically curable compounds. The UV-Vis radiation curable coating composition described herein may be a hybrid system and comprise a mixture of one or more cationically curable compounds and one or more radically curable compounds. Cationically curable compounds are cured by cationic mechanisms typically including the activation by radiation of one or more photoinitiators which liberate cationic species, such as acids, which in turn initiate the curing so as to react and/or cross-link the monomers and/or oligomers to thereby cure the radiation curable coating composition. Radically curable compounds are cured by free radical mechanisms typically including the activation by radiation of one or more photoinitiators, thereby generating radicals which in turn initiate the polymerization so as to cure the radiation curable coating composition. Depending on the monomers, oligomers or prepolymers used to prepare the binder comprised in the UV-Vis radiation curable coating compositions described herein, different photoinitiators might be used. Suitable examples of free radical photoinitiators are known to those skilled in the art and include without limitation acetophenones, benzophenones, benzyldimethyl ketals, alpha-aminoketones, alpha-hydroxyketones, phosphine oxides and phosphine oxide derivatives, as well as mixtures of two or more thereof. Suitable examples of cationic photoinitiators are known to those skilled in the art and include without limitation onium salts such as organic iodonium salts (e.g. diaryl iodoinium salts), oxonium (e.g. triaryloxonium salts) and sulfonium salts (e.g. triarylsulphonium salts), as well as mixtures of two or more thereof. Other examples of useful photoinitiators can be found in standard textbooks such as “Chemistry & Technology of UV & EB Formulation for Coatings, Inks & Paints”, Volume III, “Photoinitiators for Free Radical Cationic and Anionic Polymerization”, 2nd edition, by J. V. Crivello & K. Dietliker, edited by G. Bradley and published in 1998 by John Wiley & Sons in association with SITA Technology Limited. It may also be advantageous to include a sensitizer in conjunction with the one or more photoinitiators in order to achieve efficient curing. Typical examples of suitable photosensitizers include without limitation isopropyl-thioxanthone (ITX), 1-chloro-2-propoxy-thioxanthone (CPTX), 2-chloro-thioxanthone (CTX) and 2,4-diethyl-thioxanthone (DETX) and mixtures of two or more thereof. The one or more photoinitiators comprised in the UV-Vis radiation curable coating compositions are preferably present in a total amount from about 0.1 wt-% to about 20 wt-%, more preferably about 1 wt-% to about 15 wt-%, the weight percents being based on the total weight of the UV-Vis radiation curable coating compositions.

The radiation curable coating composition described herein may further comprise one or more marker substances or taggants and/or one or more machine readable materials selected from the group consisting of magnetic materials (different from the platelet-shaped magnetic or magnetizable pigment particles described herein), luminescent materials, electrically conductive materials and infrared-absorbing materials. As used herein, the term “machine readable material” refers to a material which exhibits at least one distinctive property which is not perceptible by the naked eye, and which can be comprised in a layer so as to confer a way to authenticate said layer or article comprising said layer by the use of a particular equipment for its authentication.

The radiation curable coating composition described herein may further comprise one or more coloring components selected from the group consisting of organic pigment particles, inorganic pigment particles, and organic dyes, and/or one or more additives. The latter include without limitation compounds and materials that are used for adjusting physical, rheological and chemical parameters of the radiation curable coating composition such as the viscosity (e.g. solvents, thickeners and surfactants), the consistency (e.g. anti-settling agents, fillers and plasticizers), the foaming properties (e.g. antifoaming agents), the lubricating properties (waxes, oils), UV stability (photostabilizers), the adhesion properties, the antistatic properties, the storage stability (polymerization inhibitors) etc. Additives described herein may be present in the radiation curable coating composition in amounts and in forms known in the art, including so-called nano-materials where at least one of the dimensions of the additive is in the range of 1 to 1000 nm.

The radiation curable coating composition described herein comprises platelet-shaped magnetic or magnetizable pigment particles described herein. Preferably, the platelet-shaped magnetic or magnetizable pigment particles are present in an amount from about 2 wt-% to about 40 wt-%, more preferably about 4 wt-% to about 30 wt-%, the weight percents being based on the total weight of the radiation curable coating composition comprising the binder material, the platelet-shaped magnetic or magnetizable pigment particles and other optional components of the radiation curable coating composition.

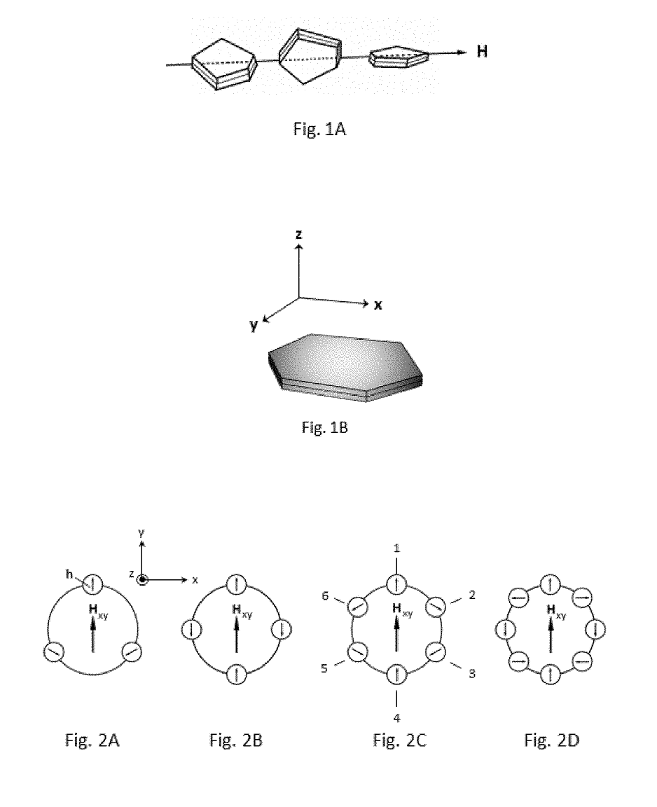

In contrast to needle-shaped pigment particles which can be considered as one-dimensional particles, platelet-shaped pigment particles are two-dimensional particles due to the large aspect ratio of their dimensions as can be seen in FIG. 1B. As shown in FIG. 1B, a platelet-shaped pigment particle can be considered as a two-dimensional structure wherein the dimensions X and Y are substantially larger than dimension Z. Platelet-shaped pigment particles are also referred in the art as oblate particles or flakes. Each platelet-shaped magnetic or magnetizable pigment particle has three axes, two main axes (referred as major axis and minor axis herein) lying in the plane of said particle, and a third axis along its thickness. As used herein, major refers to the axis along the longest dimension of said particle (or its length) and minor refers to the axis along the shortest dimension of said particle (or its width) and perpendicular to the major axis. As shown in FIG. 1B, the major axis is the x-axis and the minor axis is the y-axis. The third axis corresponding to the thickness of the platelet-shaped magnetic or magnetizable pigment particle and being substantially orthogonal to the plane formed by the major and minor axes is the z-axis. The z-axis does not play a role in the bi-axial orientation described herein. The major and minor axes are substantially perpendicular to each other and build together the X-Y plane of said particle.

Due to their platelet shape, the reflectivity of the platelet-shaped magnetic or magnetizable pigment particles is non-isotropic as the visible area of the particle depends on the direction from which it is viewed. In one embodiment, the platelet-shaped magnetic or magnetizable pigment particles having non-isotropic reflectivity due to their non-spherical shape may further have an intrinsic non-isotropic reflectivity, such as for instance in platelet-shaped optically variable magnetic or magnetizable pigment particles, due to their structure comprising layers of different reflectivity and refractive indexes. In this embodiment, the platelet-shaped magnetic or magnetizable pigment particles comprise platelet-shaped magnetic or magnetizable pigment particles having intrinsic non-isotropic reflectivity, such as platelet-shaped optically variable magnetic or magnetizable pigment particles.

Due to their magnetic characteristics, the platelet-shaped magnetic or magnetizable pigment particles described herein are machine readable, and therefore radiation curable coating compositions comprising those pigment particles may be detected for example with specific magnetic detectors. Radiation curable coating compositions comprising the platelet-shaped magnetic or magnetizable pigment particles described herein may therefore be used as a covert or semi-covert security element (authentication tool) for security documents.

Suitable examples of platelet-shaped magnetic or magnetizable pigment particles described herein include without limitation pigment particles comprising a magnetic metal selected from the group consisting of cobalt (Co), iron (Fe), gadolinium (Gd) and nickel (Ni); magnetic alloys of iron, manganese, cobalt, nickel and mixtures of two or more thereof; magnetic oxides of chromium, manganese, cobalt, iron, nickel and mixtures of two or more thereof; and mixtures of two or more thereof. The term “magnetic” in reference to the metals, alloys and oxides is directed to ferromagnetic or ferrimagnetic metals, alloys and oxides. Magnetic oxides of chromium, manganese, cobalt, iron, nickel or a mixture of two or more thereof may be pure or mixed oxides. Examples of magnetic oxides include without limitation iron oxides such as hematite (Fe₂O₃), magnetite (Fe₃O₄), chromium dioxide (CrO₂), magnetic ferrites (MFe₂O₄), magnetic spinels (MR₂O₄), magnetic hexaferrites (MFe₁₂O₁₉), magnetic orthoferrites (RFeO₃), magnetic garnets M₃R₂(AO₄)₃, wherein M stands for two-valent metal, R stands for three-valent metal, and A stands for four-valent metal.

Examples of platelet-shaped magnetic or magnetizable pigment particles described herein include without limitation pigment particles comprising a magnetic layer M made from one or more of a magnetic metal such as cobalt (Co), iron (Fe), gadolinium (Gd) or nickel (Ni); and a magnetic alloy of iron, cobalt or nickel, wherein said platelet-shaped magnetic or magnetizable pigment particles may be multilayered structures comprising one or more additional layers. Preferably, the one or more additional layers are layers A independently made from one or more materials selected from the group consisting of metal fluorides such as magnesium fluoride (MgF₂), silicium oxide (SiO), silicium dioxide (SiO₂), titanium oxide (TiO₂), zinc sulphide (ZnS) and aluminum oxide (Al₂O₃), more preferably silicium dioxide (SiO₂); or layers B independently made from one or more materials selected from the group consisting of metals and metal alloys, preferably selected from the group consisting of reflective metals and reflective metal alloys, and more preferably selected from the group consisting of aluminum (Al), chromium (Cr), and nickel (Ni), and still more preferably aluminum (Al); or a combination of one or more layers A such as those described hereabove and one or more layers B such as those described hereabove. Typical examples of the platelet-shaped magnetic or magnetizable pigment particles being multilayered structures described hereabove include without limitation A/M multilayer structures, A/M/A multilayer structures, A/M/B multilayer structures, A/B/M/A multilayer structures, A/B/M/B multilayer structures, A/B/M/B/A multilayer structures, B/M multilayer structures, B/M/B multilayer structures, B/A/M/A multilayer structures, B/A/M/B multilayer structures, B/A/M/B/A/multilayer structures, wherein the layers A, the magnetic layers M and the layers B are chosen from those described hereabove.

At least part of the platelet-shaped magnetic or magnetizable pigment particles described herein may be constituted by platelet-shaped optically variable magnetic or magnetizable pigment particles and/or platelet-shaped magnetic or magnetizable pigment particles having no optically variable properties. Preferably, at least a part of the platelet-shaped magnetic or magnetizable pigment particles described herein is constituted by platelet-shaped optically variable magnetic or magnetizable pigment particles. In addition to the overt security provided by the colorshifting property of platelet-shaped optically variable magnetic or magnetizable pigment particles, which allows easily detecting, recognizing and/or discriminating an article or security document carrying an ink, radiation curable coating composition, coating or layer comprising the platelet-shaped optically variable magnetic or magnetizable pigment particles described herein from their possible counterfeits using the unaided human senses, the optical properties of the platelet-shaped optically variable magnetic or magnetizable pigment particles may also be used as a machine readable tool for the recognition of the OEL. Thus, the optical properties of the platelet-shaped optically variable magnetic or magnetizable pigment particles may simultaneously be used as a covert or semi-covert security feature in an authentication process wherein the optical (e.g. spectral) properties of the pigment particles are analyzed. The use of platelet-shaped optically variable magnetic or magnetizable pigment particles in radiation curable coating compositions for producing an OEL enhances the significance of the OEL as a security feature in security document applications, because such materials (i.e. platelet-shaped optically variable magnetic or magnetizable pigment particles) are reserved to the security document printing industry and are not commercially available to the public.

As mentioned above, preferably at least a part of the platelet-shaped magnetic or magnetizable pigment particles is constituted by platelet-shaped optically variable magnetic or magnetizable pigment particles. These can more preferably be selected from the group consisting of platelet-shaped magnetic thin-film interference pigment particles, platelet-shaped magnetic cholesteric liquid crystal pigment particles, platelet-shaped interference coated pigment particles comprising a magnetic material and mixtures of two or more thereof.

Platelet-shaped magnetic thin film interference pigment particles are known to those skilled in the art and are disclosed e.g. in U.S. Pat. No. 4,838,648; WO 2002/073250 A2; EP 0 686 675 B1; WO 2003/000801 A2; U.S. Pat. No. 6,838,166; WO 2007/131833 Al; EP 2 402 401 A1 and in the documents cited therein. Preferably, the platelet-shaped magnetic thin film interference pigment particles comprise pigment particles having a five-layer Fabry-Perot multilayer structure and/or pigment particles having a six-layer Fabry-Perot multilayer structure and/or pigment particles having a seven-layer Fabry-Perot multilayer structure.

Preferred five-layer Fabry-Perot multilayer structures consist of absorber/dielectric/reflector/dielectric/absorber multilayer structures wherein the reflector and/or the absorber is also a magnetic layer, preferably the reflector and/or the absorber is a magnetic layer comprising nickel, iron and/or cobalt, and/or a magnetic alloy comprising nickel, iron and/or cobalt and/or a magnetic oxide comprising nickel (Ni), iron (Fe) and/or cobalt (Co).

Preferred six-layer Fabry-Perot multilayer structures consist of absorber/dielectric/reflector/magnetic/dielectric/absorber multilayer structures.

Preferred seven-layer Fabry Perot multilayer structures consist of absorber/dielectric/reflector/magnetic/reflector/dielectric/absorber multilayer structures such as disclosed in U.S. Pat. No. 4,838,648.

Preferably, the reflector layers described herein are independently made from one or more materials selected from the group consisting of metals and metal alloys, preferably selected from the group consisting of reflective metals and reflective metal alloys, more preferably selected from the group consisting of aluminum (Al), silver (Ag), copper (Cu), gold (Au), platinum (Pt), tin (Sn), titanium (Ti), palladium (Pd), rhodium (Rh), niobium (Nb), chromium (Cr), nickel (Ni), and alloys thereof, even more preferably selected from the group consisting of aluminum (Al), chromium (Cr), nickel (Ni) and alloys thereof, and still more preferably aluminum (Al). Preferably, the dielectric layers are independently made from one or more materials selected from the group consisting of metal fluorides such as magnesium fluoride (MgF₂), aluminum fluoride (AlF₃), cerium fluoride (CeF₃), lanthanum fluoride (LaF₃), sodium aluminum fluorides (e.g. Na₃AlF₆), neodymium fluoride (NdF₃), samarium fluoride (SmF₃), barium fluoride (BaF₂), calcium fluoride (CaF₂), lithium fluoride (LiF), and metal oxides such as silicium oxide (SiO), silicium dioxide (SiO₂), titanium oxide (TiO₂), aluminum oxide (Al₂O₃), more preferably selected from the group consisting of magnesium fluoride (MgF₂) and silicium dioxide (SiO₂) and still more preferably magnesium fluoride (MgF₂). Preferably, the absorber layers are independently made from one or more materials selected from the group consisting of aluminum (Al), silver (Ag), copper (Cu), palladium (Pd), platinum (Pt), titanium (Ti), vanadium (V), iron (Fe) tin (Sn), tungsten (W), molybdenum (Mo), rhodium (Rh), Niobium (Nb), chromium (Cr), nickel (Ni), metal oxides thereof, metal sulfides thereof, metal carbides thereof, and metal alloys thereof, more preferably selected from the group consisting of chromium (Cr), nickel (Ni), metal oxides thereof, and metal alloys thereof, and still more preferably selected from the group consisting of chromium (Cr), nickel (Ni), and metal alloys thereof. Preferably, the magnetic layer comprises nickel (Ni), iron (Fe) and/or cobalt (Co); and/or a magnetic alloy comprising nickel (Ni), iron (Fe) and/or cobalt (Co); and/or a magnetic oxide comprising nickel (Ni), iron (Fe) and/or cobalt (Co). When magnetic thin film interference pigment particles comprising a seven-layer Fabry-Perot structure are preferred, it is particularly preferred that the magnetic thin film interference pigment particles comprise a seven-layer Fabry-Perot absorber/dielectric/reflector/magnetic/reflector/dielectric/absorber multilayer structure consisting of a Cr/MgF₂/Al/M/Al/MgF₂/Cr multilayer structure, wherein M a magnetic layer comprising nickel (Ni), iron (Fe) and/or cobalt (Co); and/or a magnetic alloy comprising nickel (Ni), iron (Fe) and/or cobalt (Co); and/or a magnetic oxide comprising nickel (Ni), iron (Fe) and/or cobalt (Co).

The magnetic thin film interference pigment particles described herein may be multilayer pigment particles being considered as safe for human health and the environment and being based for example on five-layer Fabry-Perot multilayer structures, six-layer Fabry-Perot multilayer structures and seven-layer Fabry-Perot multilayer structures, wherein said pigment particles include one or more magnetic layers comprising a magnetic alloy having a substantially nickel-free composition including about 40 wt-% to about 90 wt-% iron, about 10 wt-% to about 50 wt-% chromium and about 0 wt-% to about 30 wt-% aluminum. Typical examples of multilayer pigment particles being considered as safe for human health and the environment can be found in EP 2 402 401 A1 which is hereby incorporated by reference in its entirety.

Platelet-shaped magnetic thin film interference pigment particles described herein are typically manufactured by a conventional deposition technique for the different required layers onto a web. After deposition of the desired number of layers, e.g. by physical vapor deposition (PVD), chemical vapor deposition (CVD) or electrolytic deposition, the stack of layers is removed from the web, either by dissolving a release layer in a suitable solvent, or by stripping the material from the web. The so-obtained material is then broken down to platelet-shaped pigment particles which have to be further processed by grinding, milling (such as for example jet milling processes) or any suitable method so as to obtain pigment particles of the required size. The resulting product consists of flat platelet-shaped pigment particles with broken edges, irregular shapes and different aspect ratios. Further information on the preparation of suitable platelet-shaped magnetic thin film interference pigment particles can be found e.g. in EP 1 710 756 A1 and EP 1 666 546 A1 which are hereby incorporated by reference.

Suitable platelet-shaped magnetic cholesteric liquid crystal pigment particles exhibiting optically variable characteristics include without limitation magnetic monolayered cholesteric liquid crystal pigment particles and magnetic multilayered cholesteric liquid crystal pigment particles. Such pigment particles are disclosed for example in WO 2006/063926 A1, U.S. Pat. No. 6,582,781 and U.S. Pat. No. 6,531,221. WO 2006/063926 A1 discloses monolayers and pigment particles obtained therefrom with high brilliance and colorshifting properties with additional particular properties such as magnetizability. The disclosed monolayers and pigment particles, which are obtained therefrom by comminuting said monolayers, include a three-dimensionally crosslinked cholesteric liquid crystal mixture and magnetic nanoparticles. U.S. Pat. No. 6,582,781 and U.S. Pat. No. 6,410,130 disclose platelet-shaped cholesteric multilayer pigment particles which comprise the sequence A¹/B/A², wherein A¹ and A² may be identical or different and each comprises at least one cholesteric layer, and B is an interlayer absorbing all or some of the light transmitted by the layers A¹ and A² and imparting magnetic properties to said interlayer. U.S. Pat. No. 6,531,221 discloses platelet-shaped cholesteric multilayer pigment particles which comprise the sequence A/B and optionally C, wherein A and C are absorbing layers comprising pigment particles imparting magnetic properties, and B is a cholesteric layer.

Suitable platelet-shaped interference coated pigments comprising one or more magnetic materials include without limitation structures consisting of a substrate selected from the group consisting of a core coated with one or more layers, wherein at least one of the core or the one or more layers have magnetic properties. For example, suitable platelet-shaped interference coated pigments comprise a core made of a magnetic material such as those described hereabove, said core being coated with one or more layers made of one or more metal oxides, or they have a structure consisting of a core made of synthetic or natural micas, layered silicates (e.g. talc, kaolin and sericite), glasses (e.g. borosilicates), silicium dioxides (SiO₂), aluminum oxides (Al₂O₃), titanium oxides (TiO₂), graphites and mixtures of two or more thereof. Furthermore, one or more additional layers such as coloring layers may be present.

The platelet-shaped magnetic or magnetizable pigment particles described herein may be surface treated so at to protect them against any deterioration that may occur in the radiation curable coating composition and/or to facilitate their incorporation in the radiation curable coating composition; typically corrosion inhibitor materials and/or wetting agents may be used.

The substrate described herein is preferably selected from the group consisting of papers or other fibrous materials, such as cellulose, paper-containing materials, glasses, metals, ceramics, plastics and polymers, metalized plastics or polymers, composite materials and mixtures or combinations thereof. Typical paper, paper-like or other fibrous materials are made from a variety of fibers including without limitation abaca, cotton, linen, wood pulp, and blends thereof. As is well known to those skilled in the art, cotton and cotton/linen blends are preferred for banknotes, while wood pulp is commonly used in non-banknote security documents. Typical examples of plastics and polymers include polyolefins such as polyethylene (PE) and polypropylene (PP), polyamides, polyesters such as poly(ethylene terephthalate) (PET), poly(1,4-butylene terephthalate) (PBT), poly(ethylene 2,6-naphthoate) (PEN) and polyvinylchlorides (PVC). Spunbond olefin fibers such as those sold under the trademark Tyvek® may also be used as substrate. Typical examples of metalized plastics or polymers include the plastic or polymer materials described hereabove having a metal disposed continuously or discontinuously on their surface. Typical example of metals include without limitation aluminum (Al), chromium (Cr), copper (Cu), gold (Au), iron (Fe), nickel (Ni), silver (Ag), combinations thereof or alloys of two or more of the aforementioned metals. The metallization of the plastic or polymer materials described hereabove may be done by an electrodeposition process, a high-vacuum coating process or by a sputtering process. Typical examples of composite materials include without limitation multilayer structures or laminates of paper and at least one plastic or polymer material such as those described hereabove as well as plastic and/or polymer fibers incorporated in a paper-like or fibrous material such as those described hereabove. Of course, the substrate can comprise further additives that are known to the skilled person, such as sizing agents, whiteners, processing aids, reinforcing or wet strengthening agents, etc. The substrate described herein may be provided under the form of a web (e.g. a continuous sheet of the materials described hereabove) or under the form of sheets. Should the OEL produced according to the present invention be on a security document, and with the aim of further increasing the security level and the resistance against counterfeiting and illegal reproduction of said security document, the substrate may comprise printed, coated, or laser-marked or laser-perforated indicia, watermarks, security threads, fibers, planchettes, luminescent compounds, windows, foils, decals and combinations of two or more thereof. With the same aim of further increasing the security level and the resistance against counterfeiting and illegal reproduction of security documents, the substrate may comprise one or more marker substances or taggants and/or machine readable substances (e.g. luminescent substances, UV/visible/IR absorbing substances, magnetic substances and combinations thereof).

The methods for producing an optical effect layer (OEL) on a substrate described herein comprises a step of bi-axially orienting the platelet-shaped magnetic or magnetizable pigment particles in a wet (i.e. not yet cured) radiation curable coating composition on the substrate. To this aim, the substrate carrying the radiation curable coating composition is moved at an appropriate speed through the center of the Halbach cylinder assembly described herein.

Carrying out a bi-axial orientation means that the platelet-shaped magnetic or magnetizable pigment particles are made to orient in such a way that their two main axes are constrained, i.e. the major and minor axes of the platelet-shaped magnetic or magnetizable pigment particles are each caused to orient according to the dynamic magnetic field. Effectively, this results in neighboring platelet-shaped magnetic pigment particles that are close to each other in space to be substantially parallel to each other.

Put another way, bi-axial orientation aligns the planes of the platelet-shaped magnetic or magnetizable pigment particles so that said planes are oriented to be substantially parallel relative to the planes of neighboring (in all directions) platelet-shaped magnetic or magnetizable pigment particles. In an embodiment, both the major and minor axes described herein are oriented by the dynamic magnetic field of the Halbach cylinder assembly so that neighboring (in all directions) pigment particles have their major and minor axes aligned with each other.

According to one embodiment, the step of carrying out a bi-axial orientation of the platelet-shaped magnetic or magnetizable pigment particles leads to a magnetic orientation wherein the platelet-shaped magnetic or magnetizable pigment particles have an orientation at a predetermined elevation angle with respect to the substrate surface, i.e. the pigment particles have their major axis (x-axis in FIG. 1B) at a substantially non-zero elevation angle to the substrate surface, aligned along the magnetic dipole field H_{xy}, and their minor axis (y-axis in FIG. 1B) substantially parallel to the substrate surface, aligned along the dynamic (i.e. time-varying) H_{z} component, the magnetic dipole field H_{xy} making a non-zero angle with the substrate surface and the dynamic H_{z} component being substantially parallel to the substrate surface, as shown on FIGS. 4A and 4B.

According to another embodiment, the step of carrying a bi-axial orientation of the platelet-shaped magnetic or magnetizable pigment particles leads to a magnetic orientation wherein said particles have their two main axes substantially parallel to the substrate surface, i.e. the pigment particles have their major axis substantially parallel to the substrate surface, aligned along the magnetic dipole field H_{xy}, and their minor axis substantially parallel to the substrate surface, aligned along the dynamic H_{z} component, both H_{xy} and H_{z} being substantially parallel to the substrate surface. For such an alignment, the platelet-shaped magnetic or magnetizable pigment particles are planarized within the radiation curable coating composition on the substrate with their major and minor axes being parallel to the substrate surface.

The Halbach cylinder assembly described herein comprises a) a conventional Halbach cylinder as described hereabove in combination with one or more magnet-wire coils.

With reference to FIG. 2A-D, conventional Halbach cylinders comprises three (FIG. 2a), four (FIG. 2B), six (FIG. 2C), eight (FIG. 2D), or more transversally magnetized magnet bars of a same length and strength, said magnet bars being equidistantly arranged on a circle and having their magnetization directions (denoted hereafter h) in the plane of the circle (hereafter called the xy-plane). The Halbach cylinder can have an arbitrary length in the direction orthogonal to the plane of the circle, hereafter called the z-direction. The magnetization directions (h) of the individual three or more magnet bars of the Halbach cylinder are oriented such as to conjointly produce a homogeneous magnetic dipole field (H_{xy}) inside the Halbach cylinder, whose direction in the xy-plane is set through an appropriate rotation of said magnet bars. By virtue of the same arrangement, the magnetic field outside the Halbach cylinder is canceled. A Halbach cylinder requires ω=2Ω (wherein ω stands for the orientation angle of its magnetization direction (h) and Ω stands for the angular position of a magnet bar on the circle of the Halbach cylinder), i.e. the orientation angle of the magnetization direction (h) of the magnet bar is always twice its angular position on the circle.

FIG. 2C illustrates an example of a Halbach cylinder comprising six magnet bars. The first magnet bar (1) is placed at an angle Ω=0° with respect to the y-axis taken as a reference. Its magnetization direction (h) also has an angle ω=0° with respect to the y-axis. The second magnet bar (2) is placed at an angle Ω=60° with respect to the y-axis, and its magnetization direction (h) has an angle ω=120° with respect to the y-axis. This continues for the third magnet bar (3) (Ω=120°, ω=240°), the fourth magnet bar (4) (Ω=180°, ω=360° or 0°), the fifth magnet bar (5) (Ω=240°, ω=120°) and the sixth (6) magnet bar (Ω=300°, ω=240°). This arrangement of the individual magnet bars results in a magnetic dipole field (H_{xy}) having a direction collinear to the y-axis.

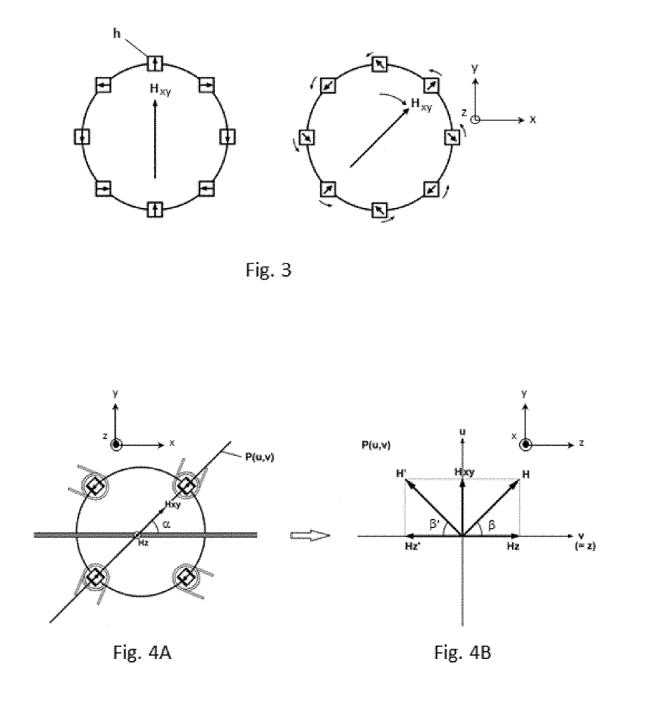

The direction of the magnetic dipole field (H_{xy}) inside the Halbach cylinder can be freely set to any value by a concerted individual in-place rotation of all magnet bars of the Halbach cylinder in a same sense. As shown in FIG. 3, a counter-clockwise rotation of all magnet bars by a given angle results in a clockwise rotation of the direction of the resulting magnetic dipole field (H_{xy}) by the same angle. This allows for a free choice of the direction of the magnetic dipole field (H_{xy}) in the xy-plane inside the Halbach cylinder, without the need to rotate the Halbach cylinder as such.

Halbach cylinders have a series of useful properties which are exploited in the present invention, including that
a) the magnetic dipole field (H_{xy}) of a Halbach cylinder is transversal, homogeneous, and confined to the interior of the cylinder. This allows for the construction of magnetization units extending over an arbitrary length in the z-direction, and
b) the magnet bars of the Halbach cylinder must not form a closed surface, but may be conveniently spaced apart. This allows for the easy passing of the substrate carrying the radiation curable coating composition through the magnetic field area of the Halbach cylinder, as well as for the adjunction of and access to functional units inside the Halbach cylinder.

The Halbach cylinder assembly described herein comprises three or more magnet bars of an appropriate size. The magnet bars described herein are made of high-coercivity materials (also referred as strong magnetic materials). Suitable high-coercivity materials are materials having a maximum value of energy product (BH)ₘₐₓ of at least 20 kJ/m³, preferably at least 50 kJ/m³, more preferably at least 100 kJ/m³, even more preferably at least 200 kJ/m³. They are preferably made of one or more sintered or polymer bonded magnetic materials selected from the group consisting of Alnicos such as for example Alnico 5 (R1-1-1), Alnico 5 DG (R1-1-2), Alnico 5-7 (R1-1-3), Alnico 6 (R1-1-4), Alnico 8 (R1-1-5), Alnico 8 HC (R1-1-7) and Alnico 9 (R1-1-6); hexaferrites of formula MFe₁₂0₁₉, (e.g. strontium hexaferrite (SrO*6Fe₂0₃) or barium hexaferrites (BaO*6Fe₂0₃)), hard ferrites of the formula MFe₂0₄ (e.g. as cobalt ferrite (CoFe₂0₄) or magnetite (Fe₃O₄)), wherein M is a bivalent metal ion), ceramic 8 (SI-1-5); rare earth magnetic materials selected from the group comprising RECo₅ (with RE=Sm or Pr), RE₂TM₁₇ (with RE=Sm, TM=Fe, Cu, Co, Zr, Hf), RE₂TM₁₄B (with RE=Nd, Pr, Dy, TM =Fe, Co); anisotropic alloys of FeCrCo; materials selected from the group of PtCo, MnAlC, RE Cobalt 5/16, RE Cobalt 14. Preferably, the high-coercivity materials of the magnet bars are selected from the groups consisting of rare earth magnetic materials, and more preferably from the group consisting of Nd₂Fe₁₄B and SmCo₅. Alternatively and with the aim of making extended magnet bars, a number of smaller permanent magnets (M1, M2, M3, . . . Mn) may be assembled in an appropriate mechanical holder which keeps them in place in correct polarity, such as to form together an extended composite magnet bar.

The mechanical holder may consist of a single piece or may be an assembly of multiple components. The mechanical holder is preferably made of one or more non-magnetic materials selected from the group consisting of low conducting materials, non-conducting materials and mixtures thereof, such as for example engineering plastics and polymers, aluminum, aluminum alloys, titanium, titanium alloys and austenitic steels (i.e. non-magnetic steels). Engineering plastics and polymers include without limitation polyaryletherketones (PAEK) and its derivatives polyetheretherketones (PEEK), poletherketoneketones (PEKK), polyetheretherketoneketones (PEEKK) and polyetherketoneetherketoneketone (PEKEKK); polyacetals, polyamides, polyesters, polyethers, copolyetheresters, polyimides, polyetherimides, high-density polyethylene (HDPE), ultra-high molecular weight polyethylene (UHMWPE), polybutylene terephthalate (PBT), polypropylene, acrylonitrile butadiene styrene (ABS) copolymer, fluorinated and perfluorinated polyethylenes, polystyrenes, polycarbonates, polyphenylenesulfide (PPS) and liquid crystal polymers. Preferred materials are PEEK (polyetheretherketone), POM (polyoxymethylene), PTFE (polytetrafluoroethylene), Nylon® (polyamide) and PPS. Titanium-based materials have the advantage of excellent mechanical stability and low electric conductivity, while aluminum or aluminum alloys-based materials have the advantage of being easily worked.

The Halbach cylinder assembly described herein preferably comprises a low number of magnet bars, preferably from three to eight magnet bars, and more preferably four magnet bars arranged in a square, such as to allow for an open construction and for the easy passing of the substrate carrying the radiation curable coating composition through the Halbach cylinder assembly. The magnet bars are rotatably fixed in a frame, such as to be individually rotatable in a concerted way, in order to allow for the setting of the direction of the magnetic dipole field (H_{xy}) in the xy-plane inside the Halbach cylinder assembly.

With the aim of achieving a bi-axial orientation of the platelet-shaped magnetic or magnetizable pigment particles, a dynamic z-component (H_{z}) is added to the magnetic dipole field (H_{xy}) generated by the three or more magnet bars of the Halbach cylinder assembly by applying an AC current of appropriate amplitude and frequency to the magnet-wire coils, said appropriate amplitude and frequency being set according to the characteristics of the coating composition (e.g. its viscosity and/or the particle size distribution of the platelet-shaped magnetic or magnetizable pigment particles). Said dynamic z-component (H_{z}) is added to the magnetic dipole field (H_{xy}) in the xy-plane. This produces a rotation of the platelet-shaped magnetic or magnetizable pigment particles by an angle β (FIG. 4B) of at least ±10°, i.e. totally (β+β′=2β) at least ±20°, preferably at least ±20° (i.e. totally at least 40°), more preferably at least ±30° (i.e. totally at least 60°), even more preferably at least ±45° (i.e. totally at least 90°), upon cycling said AC current in the magnet-wire coils. The platelet-shaped magnetic or magnetizable pigment particles perform at least one rotation (i.e. they oscillate at least once back and forth by said angle) while the radiation curable coating composition is inside the Halbach cylinder assembly. Preferably, said platelet-shaped magnetic or magnetizable pigment particles perform two or more, more preferably five or more, and even more preferably ten or more rotations while the radiation curable coating composition is inside the Halbach cylinder assembly. Before leaving the Halbach cylinder assembly, the radiation curable coating composition is at least partially cured as described herein.

Accordingly and in addition to the three or more magnet bars, the Halbach cylinder assembly comprises one or more magnet-wire coils.

By varying the electric current in the one or more magnet-wire coils, e.g. by the means of an AC current, the magnetic dipole field (H_{xy}) in the xy-plane receives an additional dynamic z-component (H_{z}); i.e. the resulting magnetic dipole field (H_{xyz}) oscillates in a plane P given by the equations P(u,v): x=ux₀; y=uy₀; z=v, x₀ and y₀ being the projection of the magnetic dipole field (H_{xy}) on the x-axis and y-axis, respectively (FIG. 4A). As shown in FIG. 4A, the magnetic dipole field (H_{xy}) makes an angle α with the xz-plane (the plane of the substrate carrying the radiation curable coating composition). By adding a dynamic z-component (H_{z}), the magnetic dipole field (H_{xyz}=Hᵤᵥ) oscillates in the plane P(u,v). FIG. 4B is a view of P(u,v), perpendicularly crossing the xy-plane. H and H′ represent two directions of the oscillating magnetic dipole field (Hᵤᵥ), when the z-component is added as an orthogonal component (H_{z′}) respectively (H_{z}), β and β′ being the angles between H respectively H′ and the z-axis.

According to one embodiment, the magnet-wire coil for generating the z-component of the oscillating magnetic dipole field (Hᵤᵥ) can be embodied as a single magnet-wire coil surrounding the Halbach cylinder assembly. This is depicted on FIG. 5A, where 7a indicates the single magnet-wire coil and 8 indicates magnet bars. This, however, impairs the access of the substrate carrying the radiation curable coating composition to the Halbach cylinder assembly (9). Preferably and with the aim of not impairing the access of the substrate to the Halbach cylinder assembly (9), the Halbach cylinder assembly comprises, as depicted on FIG. 5B, two magnet-wire coils (7b-1, 7b-2), which are disposed at both ends of the previously described Halbach cylinder assembly (9) presented in an orthogonal view, the magnet-wire coils (7b-1, 7b-2) being wound around the poles of a pole piece (10a) that serves to magnetically connect them. H_{z} indicates the dynamic z-component of the oscillating magnetic dipole field (Hᵤᵥ). This solution can be applied for Halbach cylinders of moderate length, but it is not scalable to Halbach cylinders of arbitrary lengths.

Preferably and as depicted for example in FIG. 6, the one or more magnet-wire coils for generating the dynamic z-component (H_{z}) of the oscillating magnetic dipole field (Hᵤᵥ) can be embodied as a number of independent magnet-wire coils (7c), each of them preferably surrounding a magnet bar (8) so as to form three or more structures, each of said three or more structures comprising a magnet bar (8) and a magnet-wire coil (7c) surrounding said magnet bar (8). This embodiment allows to keep the construction sufficiently open for the easy passing of the substrate (11) carrying the radiation curable coating composition (12) through it, and it scales to arbitrary lengths in the z-direction.

With the aim of exhibiting a sufficient strength of the dynamic z-component (H_{z}) of the oscillating magnetic dipole field (Hᵤᵥ), the structures comprising a magnet bar (8) and a magnet-wire coil (7c) surrounding said magnet bar (8) described herein are additionally loaded with pole pieces made of a low-coercivity, high-saturation material (also referred in the art as a soft magnetic material). Suitable low-coercivity, high-saturation materials have a coercivity lower than 1000 A·m⁻¹, to allow for a fast magnetization and demagnetization, and their saturation is preferably at least 1 Tesla, more preferably at least 1.5 Tesla, and even more preferably at least 2 Tesla. The low-coercivity, high-saturation materials described herein include without limitation soft magnetic iron (from annealed iron and carbonyl iron), nickel, cobalt, soft ferrites like manganese-zinc ferrite or nickel-zinc ferrite, nickel-iron alloys (like permalloy-type materials), cobalt-iron alloys, silicon iron and amorphous metal alloys like Metglas® (iron-boron alloy), preferably pure iron and silicon iron (electrical steel), as well as cobalt-iron and nickel-iron alloys (permalloy-type materials), and more preferably pure iron.

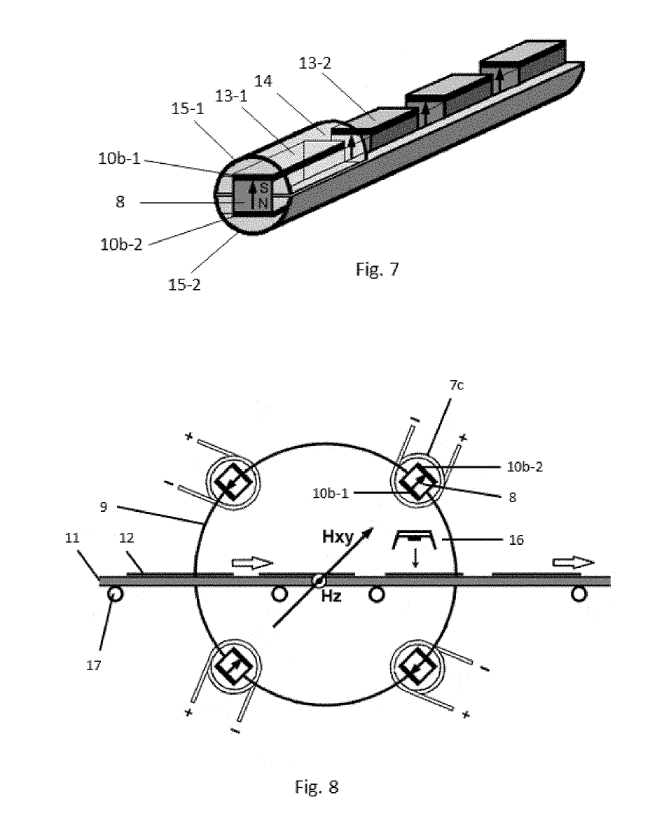

The magnet bars described herein can be made of continuous, monolithic magnets. Alternatively and as shown in FIG. 7, in the case of long magnet bars, split magnets may be advantageously used. Therein, a plurality of individual magnets having their North-South axes pointing along a same direction (13-1, 13-2) are assembled in a two-parts holder (15-1, 15-2), such as to facilitate the mounting of the magnets (13-1, 13-2). The individual magnets in the holder (13-1, 13-2) may be advantageously separated by gaps (14), such as air gaps or gaps filled with a non-magnetic material such as aluminum, titanium, or with a plastic material, in order to facilitate the assembling of the magnets. Said gaps may advantageously serve for accommodating fixation elements, such as screws, rivets and the like, preferably made of a non-magnetic material such as those described hereabove for the materials of the holder, which have the function of keeping the holder parts (15-1, 15-2) together against the magnetic repulsion forces acting between the individual magnets. The magnet bar with split magnets also comprises pole pieces as described hereabove. In a preferred embodiment, each split magnet (13-1, 13-2) is made of an individual magnet carrying two individual pole pieces (10b-1, 10b-2) positioned at the South and North poles of the individual magnets. In an alternative embodiment—not shown—the pole pieces are part of the holder (15-1, 15-2); in such a case they may be contiguous and run along the whole length of the holder parts (15-1, 15-2). In still another embodiment,—not shown—the holder parts (15-1, 15-2) or parts of them are made of a low-coercivity, high saturation material, such as to serve as the pole pieces. In any case, the pole pieces must be made such as not short-circuiting out the magnetic field between the poles of the magnets.

The saturation of the low-coercivity, high-saturation material should be high enough so that saturation is not reached when said material is combined with the high-coercivity material of the magnet bars. By carefully selecting the high-coercivity material of the magnet bars and the low-coercivity, high-saturation material of the pole pieces, there remains enough margin left for adding more magnetization in the z-direction. On the contrary, the high-coercivity material does not contribute to reinforce the z-component of the field generated by the magnet coils due to its domain walls being “pinned” (i.e. fixed) under the applied conditions; only the low-coercivity, high-saturation material can contribute to this.

According to one embodiment and as depicted in FIG. 8, the Halbach cylinder assembly comprises four structures, each of said four structures comprising a magnet bar (8) surrounded with a magnet-wire coil (7c), said structures being disposed in a square arrangement such as to make up a Halbach cylinder assembly (9). The embodiment having a Halbach cylinder assembly comprising four structures described herein has the advantage of being largely open on all sides and thus easy to operate in conjunction with other functional units, whilst still offering a sufficiently large zone of homogeneous magnetic field in its interior. Accordingly, there is enough space left so that the substrate (11) carrying the radiation curable coating composition (12) and being supported by rollers (17) or equivalent substrate supporting or guiding means can pass through the Halbach cylinder assembly (9). As mentioned hereabove, each structure comprises one or more pole pieces (10b-1, 10b-2) made of the low-coercivity and high saturation material described herein.

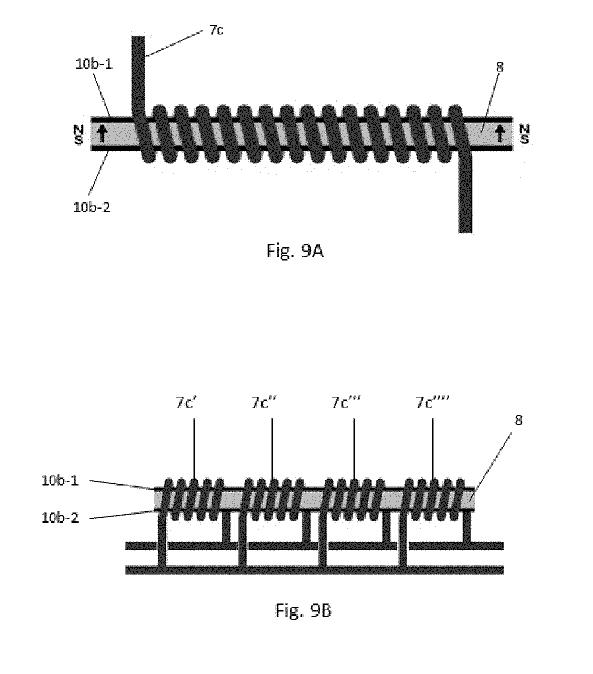

FIG. 9A more precisely depicts one structure of the Halbach cylinder assembly of FIG. 8. The structure comprises a transversally magnetized magnet bar (8), a magnet-wire coil (7c) and two pole pieces (10b-1, 10b-2). The magnetization direction S→N of the magnet bar is indicated by an arrow. There must be enough difference between the strength of the magnetic field generated by the high-coercivity material of the magnet bar and the saturation of the low-coercivity, high-saturation material chosen for the pole pieces so that the magnet-wire coil is able to generate a dynamic magnetic field of sufficient strength in the z-direction. For example, pure iron has a saturation of 2 Tesla (Kaye and Laby online, 2.6.6. Magnetic Properties of Materials, 1995). If the high-coercivity material chosen for the magnet bar is sintered Nd₂Fe₁₄B, which exhibits a magnetic remanence (i.e. the remaining magnetic field B when the magnetization field H returns to zero) of between 1 and 1.4 Tesla (Nd—Fe—B Magnets, Properties and Applications, Michael Weickhmann, Vacuumschmelze GmbH & Co. KG), a dynamic magnetic field with a strength of 0.6 to 1 Tesla may be added in the z-direction before saturation is reached in the low-coercivity, high-saturation material of the pole pieces.

Preferably, the Halbach cylinder assembly described herein comprises three or more structures, each of said three or more structures comprising a magnet bar and a magnet-wire coil surrounding said magnet bar, wherein the magnet-wire coil of each of said three or more structures is a composite magnet-wire coil comprising a number of mechanically individual smaller coils (W1, W2, W3, . . . Wn) which are electrically connected to together make up the complete magnet-wire coil. Said electrical connection of the individual smaller coils (W1, W2, W3, . . . Wn) may be a series connection, which assures that a same current is flowing through all coils. However, preferably, said electrical connection of the individual smaller coils (W1, W2, W3, . . . Wn) is a parallel connection, which has the advantage of lowering the total inductivity, such that the coils may be driven at ease with alternating current at higher frequency. FIG. 9B depicts an example of this embodiment, wherein the magnet-wire coil (7c) is made of four individual magnet-wire coils (7c′, 7c″, 7c′″, 7c″″) connected in a parallel arrangement.

The magnet-wire coils and the pole pieces made of low-coercivity, high-saturation material have to be independently dimensioned such as to produce a dynamic magnetic field of sufficient strength in the z-direction while keeping the heat production due to the coil resistance in tolerable limits. This requires a rather high amount of low-coercivity, high-saturation material, such as soft magnetic iron or silicon iron, i.e. pole pieces of rather large dimensions. The magnet-wire coils described herein are preferably made of one or more tight layers of standard magnet wire having a copper or aluminum core and one or more insulation layers wound around the holder of the magnet bar or around the optional pole pieces. Preferably, the magnet wire is of the “self-bonding” type, which means that the insulating layers are covered with a thermoplastic adhesive layer which can be activated by heat (hot air or oven) or by appropriate solvents. This allows the production of self-standing magnet-wire coils through a simple baking or solvent exposure after their winding onto an appropriate support. The magnet bar and the optional holder/pole piece are then inserted into the magnet-wire coils, which are electrically connected such that they cooperate in producing the z-component of the dynamic magnetic field (H_{z}). In the figures, the sense of connection of the coils is indicated with (+) and (−) signs.

According to one embodiment, the Halbach cylinder assembly comprises more than four structures, such as for example six or eight structures, each of said structures comprising a magnet bar surrounded with a magnet-wire coil. Increasing the number of said structures typically improve the volume of the zone of homogeneous magnetic field inside the Halbach cylinder assembly while reducing accessibility to its interior. FIGS. 12A and 12B show magnetic field simulations for the embodiments with four and eight magnet bars respectively. The homogeneity of the magnetic field in the interior of the Halbach cylinder assemblies can be appreciated from these figures. The magnetic field simulations have been performed with the software Vizimag 3.19.

The methods for producing the OEL described herein comprises a step of at least partially curing the radiation curable coating composition so as to fix/freeze the orientation and position of the platelet-shaped magnetic or magnetizable pigment particles in the radiation curable coating composition. By “at least partially curing the radiation curable coating composition”, it is meant that the curing step may not be complete when the coating composition leaves the Halbach cylinder assembly. The step of at least partially curing the radiation curable coating composition should be sufficient so that the radiation curable coating composition reaches a viscosity high enough to ensure that the platelet-shaped magnetic or magnetizable pigment particles do not completely or partially lose their orientation during and/or after the coating composition has left the Halbach cylinder assembly. The step of at least partially curing the radiation curable coating composition may be then completed by passing the radiation curable composition under an optional additional curing unit, downstream to the Halbach cylinder assembly.

The curing step c) is carried out by using a curing unit while the substrate carrying the radiation curable coating composition is still inside the Halbach cylinder assembly, i.e. the at least partially curing step is carried out partially simultaneously or simultaneously with the step of bi-axially orienting the platelet-shaped magnetic or magnetizable pigment particles. This prevents any disturbing of the achieved orientation when the substrate leaves the homogeneous magnetic field region of the Halbach cylinder assembly. The term “partially simultaneously” as used herein denotes that two steps are partly performed simultaneously, i.e. the times of performing each of the steps partially overlap. In the context described herein, when curing is performed partially simultaneously with the bi-axial orientation step, it must be understood that curing becomes effective after the orientation so that the platelet-shaped magnetic or magnetizable pigment particles orient before the complete curing of the OEL.

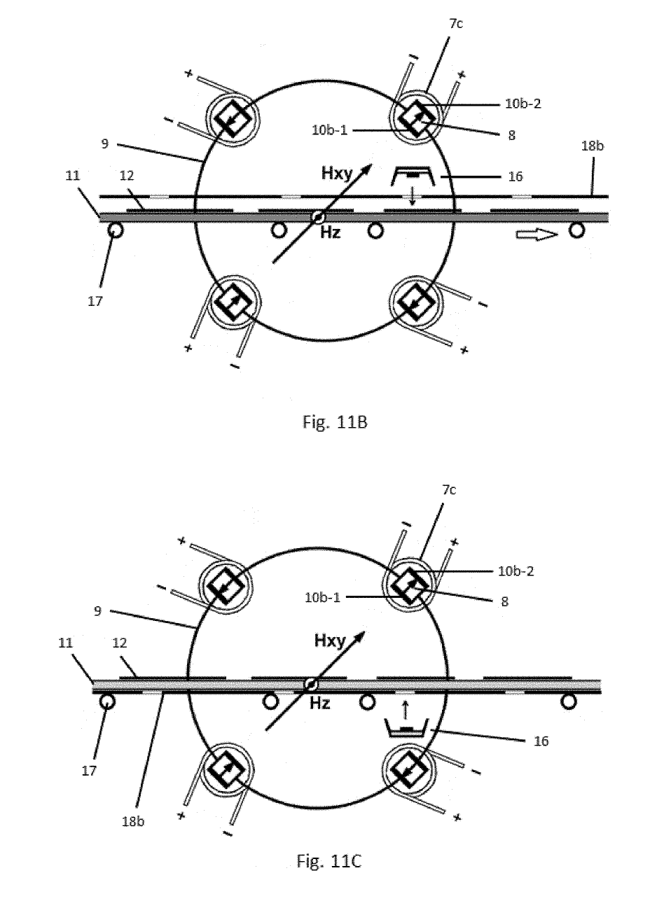

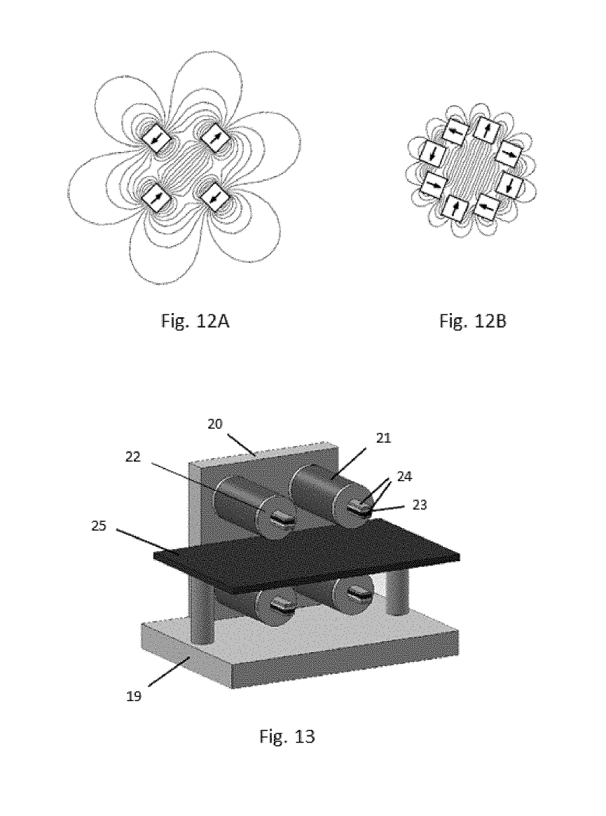

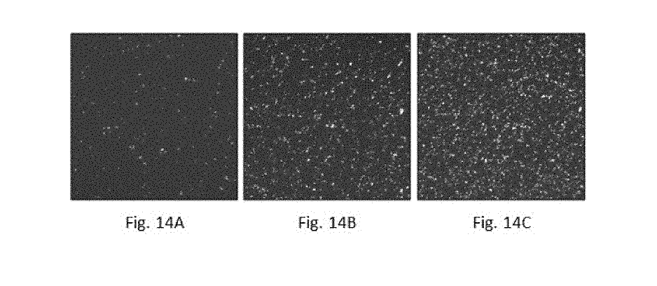

As shown in FIGS. 8, 11A and 11B, the curing unit (16) is preferably positioned on the same side of the substrate (11) as the radiation curable coating composition (12), in the border part of the region of the Halbach cylinder assembly (9) wherein the magnetic dipole field (H_{xy}) is homogeneous, opposite to the side wherein the substrate (11) enters the Halbach cylinder assembly (9).

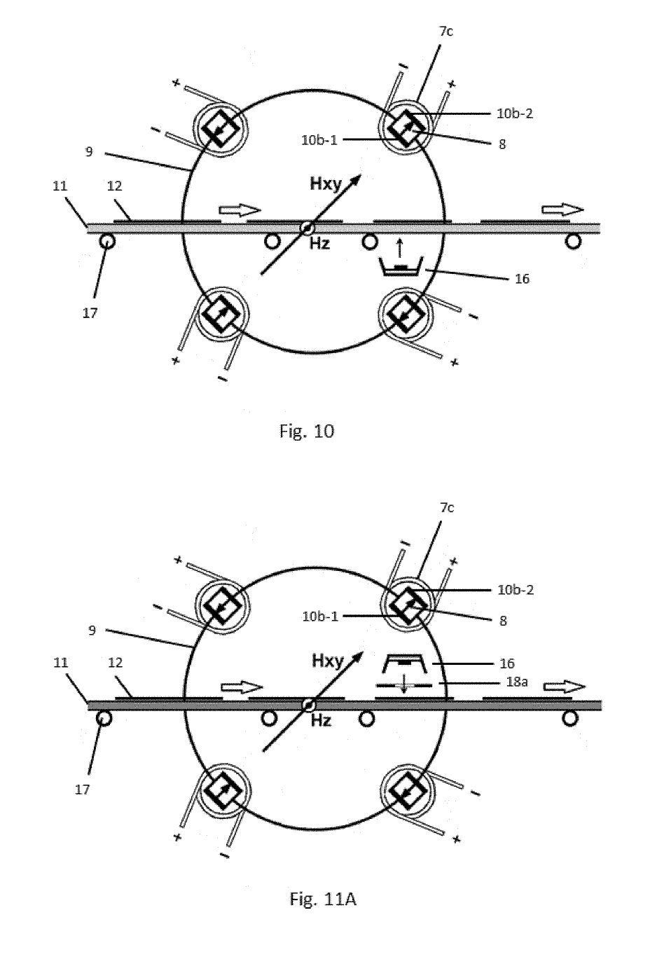

Alternatively, and as described in the not yet published European patent application 14178901.6, the curing step may be carried out through the substrate, provided that the substrate is sufficiently transparent to at least part of the emission spectrum of the radiation. By “sufficiently transparent”, it is meant that the substrate exhibits a transmission of electromagnetic radiations of at least 4%, preferably at least 8% at one or more wavelengths of the emission spectrum of the radiation source in the range of 200 nm to 500 nm. In this case, and as shown on FIGS. 10 and 11C, the curing unit (16) is positioned below the substrate (11) carrying the radiation curable coating composition (12), provided that said substrate (11) is transparent enough at the wavelength of the irradiation source used in the curing unit to ensure sufficient curing of the radiation curable coating composition (12).

To this aim, the device described herein comprises a curing unit (16), wherein said curing unit (16) allows for an irradiation with a sufficient strength to induce at least a partial curing of the radiation curable coating composition, and to raise herewith its viscosity so that the oriented platelet-shaped magnetic or magnetizable pigment particles do no longer change their orientation and position. A complete curing can be achieved through a post-curing step, via passage of the radiation curable composition through an optional additional curing unit disposed downstream of the Halbach cylinder assembly.

The curing unit (16) described herein preferably comprises one or more UV-lamps. Said one or more UV-lamps are preferably selected from the group consisting of light emitting Diode (LED) UV-lamps, arc discharge lamps (such as a medium-pressure mercury arc (MPMA) or a metal-vapor arc lamp), mercury lamps and combination thereof. Additionally, one or more UV-lamps may be placed outside the Halbach cylinder assembly and equipped with a waveguide directing the irradiation towards one or the other side of the substrate carrying the radiation curable coating composition, depending on the embodiments described hereabove. When the one or more UV-lamps are placed within the Halbach cylinder assembly, powerful and low-volume LED UV-lamps are preferred due to space constraints. Since LED UV-lamps have different spectral characteristics compared to mercury UV-lamps and, as known by the man skilled in the art, the radiation curable coating composition has to be modified accordingly. Especially, photoinitiators and reactive monomers and oligomers have to be adapted to the longer wavelength (typically around 385 nm) and narrower emission band (typically +/−20nm) of the LED UV-lamps.

The curing unit (16) preferably comprises an array of UV- or blue-light Power-LEDs, said array being either directly mounted inside the Halbach cylinder assembly (9), or its radiation is guided via a radiation-guiding system (e.g. a fiber optic device) from an appropriate UV- or blue-light source outside the Halbach cylinder assembly (9) to the appropriate location over the substrate.

The present invention further provides a process for producing an OEL on a substrate, said OEL comprising a motif made of a first pattern and a second pattern which is adjacent to the first pattern, said motif being made of the radiation curable coating composition described herein. The motif described herein comprises a) a first pattern wherein at least a part of the platelet-shaped magnetic or magnetizable pigment particles are oriented so as to follow a bi-axially orientation, in particular the at least part of the platelet-shaped magnetic or magnetizable pigment particles i) have their major and minor axes substantially parallel to the substrate surface, or ii) have their major axis at a substantially non-zero elevation angle to the substrate surface and their minor axis substantially parallel to the substrate surface and b) a second pattern wherein at least a part of the platelet-shaped magnetic or magnetizable pigment particles are oriented so as to follow an orientation which is different from the orientation of the platelet-shaped magnetic or magnetizable pigment particles of the first pattern and follow any orientation except a random orientation. Magnetic orientation of the platelet-shaped magnetic or magnetizable pigment particles of the second pattern may be carried out by exposing said pigment particles to a dynamic magnetic field of a magnetic-field generating device or by exposing said pigment particles to a static magnetic field of a magnetic-field generating device, depending on the required orientation pattern. The magnetic orientation of the platelet-shaped magnetic or magnetizable pigment particles of the second pattern described herein is carried out subsequently to the orientation of the pigment particles and at least partial curing of the first pattern, i.e. the second magnetic orientation step is carried out after the substrate has left the Halbach cylinder assembly.

Such a process comprises the steps of:
a) applying on a surface of the substrate described herein the radiation curable coating composition comprising platelet-shaped magnetic or magnetizable pigment particles described herein, said radiation curable composition being in a first state,
b) exposing the motif made of the radiation curable coating composition to a dynamic magnetic field of a magnetic assembly comprising a Halbach cylinder assembly comprising either i) three or more magnet bars and a single magnet-wire coil surrounding said assembly, or ii) three or more magnet bars, a pole piece encompassing said assembly and comprising two poles facing said assembly, each pole being surrounded by a magnet-wire coil, or iii) three or more structures, each of said three or more structures comprising a magnet bar and a magnet-wire coil surrounding said magnet bar such as those described herein, so as to bi-axially orient at least a part of the platelet-shaped magnetic or magnetizable pigment particles, said three or more magnet bars being transversally magnetized,
c) at least partially curing the first pattern of the motif made of the radiation curable coating composition of step b) to a second state so as to fix the platelet-shaped magnetic or magnetizable pigment particles of the first pattern in their adopted positions and orientations, said step c) being carried out partially simultaneously or simultaneously with step b), wherein the partially curing step is carried out with a curing unit comprising a photomask such that the second pattern is not exposed to irradiation,
d) exposing the motif made of the radiation curable coating composition of step c), wherein the second pattern is in a first state due to the presence of the photomask under step c), to the magnetic field of a magnetic-field-generating device thereby orienting at least part of the platelet-shaped magnetic or magnetizable pigment particles of the second pattern so as to follow an orientation which is different from the orientation of the platelet-shaped magnetic or magnetizable pigment particles of the first pattern and follow any orientation except a random orientation, and
e) simultaneously, partially simultaneously or subsequently curing the radiation curable composition to a second state so as to fix the platelet-shaped magnetic or magnetizable pigment particles in their adopted positions and orientations.

With the aim of producing OELs comprising the motif made of the first pattern and the second pattern described herein, the use during step c) of the curing unit comprising a photomask allows for a selective curing of the radiation curable coating composition at one or more predetermined locations. When the radiation curable coating composition leaves the Halbach cylinder assembly, the second pattern made of the radiation curable coating composition that has not been exposed to the curing unit comprises platelet-shaped magnetic or magnetizable pigment particles in a non-fixed or non-frozen oriented state. Said platelet-shaped magnetic or magnetizable pigment particles may therefore be further oriented and fixed in a subsequent step. The subsequent orientation is different from the orientation of the platelet-shaped magnetic or magnetizable pigment particles of the first pattern and is any orientation except a random orientation. The desired orientation of the platelet-shaped magnetic or magnetizable pigment particles obtained by exposing them to the subsequent orientation step is chosen according to the end-use applications.

By a different orientation, it is meant that the at least part of the platelet-shaped magnetic or magnetizable pigment particles of the second pattern follows:
i) a completely different orientation pattern, or
ii) a bi-axial orientation which is different from the bi-axial orientation of the first pattern such as for example a) the first pattern comprises pigment particles having their two major and minor axes substantially parallel to the substrate surface and b) the second pattern comprises pigment particles having their major axis within the X-Y plane at a substantially non-zero elevation angle to the substrate surface and their minor axis substantially parallel to the substrate surface.

Typical examples of orientation patterns different from the bi-axial orientation described herein and suitable for the second pattern are described hereabove. OEL known as flip-flop effects (also referred in the art as switching effect) may be produced. Flip-flop effects include a first printed portion and a second printed portion separated by a transition, wherein platelet-shaped pigment particles are aligned parallel to a first plane in the first portion and platelet-shaped pigment particles in the second portion are aligned parallel to a second plane. Methods for producing flip-flop effects are disclosed for example in EP 1 819 525 B1 and EP 1 819 525 B1. Optical effects known as rolling-bar effects may also be produced. Rolling-bar effects show one or more contrasting bands which appear to move (“roll”) as the image is tilted with respect to the viewing angle, said optical effects are based on a specific orientation of magnetic or magnetizable pigment particles, said pigment particles being aligned in a curving fashion, either following a convex curvature (also referred in the art as negative curved orientation) or a concave curvature (also referred in the art as positive curved orientation). Methods for producing rolling-bar effects are disclosed for example in EP 2 263 806 A1, EP 1 674 282 B1, EP 2 263 807 A1, WO 2004/007095 A2 and WO 2012/104098 A1. Optical effects known as Venetian-blind effects may also be produced. Venetian-blind effects include pigment particles being oriented such that, along a specific direction of observation, they give visibility to an underlying substrate surface, such that indicia or other features present on or in the substrate surface become apparent to the observer while they impede the visibility along another direction of observation. Methods for producing Venetian-blind effects are disclosed for example in U.S. Pat. No. 8,025,952 and EP 1 819 525 B1. Optical effects known as moving-ring effects may also be produced. Moving-ring effects consists of optically illusive images of objects such as funnels, cones, bowls, circles, ellipses, and hemispheres that appear to move in any x-y direction depending upon the angle of tilt of the OEL. Methods for producing moving-ring effects are disclosed for example in EP 1 710 756 A1, U.S. Pat. No. 8,343,615, EP 2 306 222 Al, EP 2 325 677 A2, WO 2011/092502 A2 and US 2013/084411.

The magnetic-field-generating device used for the magnetic orientation of platelet-shaped magnetic or magnetizable pigment particles of the second pattern may further comprise an engraved magnetic plate such as those disclosed for example in WO 2005/002866 A1 and WO 2008/046702 A1. Such an engraved plate may be made from iron. Alternatively, such an engraved plate may be made from a plastic material wherein magnetic particles are dispersed (such as for example Plastoferrite). In this way, the optical effect of the second pattern can be overlaid with a magnetically induced fine-line pattern, such as a text, an image or a logo.

A bi-axial orientation performed so that at least a part of the platelet-shaped magnetic or magnetizable pigment particles of the second pattern i) have their major and minor axes substantially parallel to the substrate surface, or ii) have their major axis at a substantially non-zero elevation angle to the substrate surface and their minor axis substantially parallel to the substrate surface may be obtained by using a Halbach cylinder assembly such as those described herein. In such a case, the at least partially curing step e) is carried out partially simultaneously or simultaneously with step d).

Alternatively, a bi-axial orientation may be performed so that at least a part of the platelet-shaped magnetic or magnetizable pigment particles of the second pattern i) have their major and minor axes substantially parallel to the substrate surface, ii) have their major axis at a substantially non-zero elevation angle to the substrate surface and their minor axis substantially parallel to the substrate or iii) have their major and minor axes parallel to an imaginary spheroid surface. Such bi-axial orientation may be carried out by using a magnetic-field-generating device such as those disclosed in EP 2 157 141 A1, U.S. Pat. No. 4,859,495 and Z. Q. Zhu and D. Howe (Halbach permanent magnet machines and applications: a review, IEE. Proc. Electric Power Appl., 2001, 148, p. 299-308), US 2007/0172261 or in co-pending European patent application 13 195 717.7.

The magnetic-field-generating device disclosed in EP 2 157 141 A1 provides a dynamic magnetic field that changes its direction forcing the platelet-shaped magnetic or magnetizable pigment particles to rapidly oscillate until their major and minor axes become substantially parallel to the substrate surface, i.e. the platelet-shaped magnetic or magnetizable pigment particles rotate until they come to the stable sheet-like formation with their major and minor axes parallel to the substrate surface and are planarized in said two dimensions. As shown in FIG. 5 of EP 2 157 141 A1, the magnetic-field-generating device comprises a linear arrangement of at least three magnets that are positioned in a staggered fashion or in zigzag formation, said at least three magnets being on opposite sides of a feedpath where magnets at the same side of the feedpath have the same polarity, which is opposed to the polarity of the magnet(s) on the opposing side of the feedpath in a staggered fashion. The arrangement of the at least three magnets provides a predetermined change of the field direction as platelet-shaped magnetic or magnetizable pigment particles in a coating composition (move by the magnets (direction of movement: arrow). The disclosed magnetic-field-generating device comprises a) a first magnet and a third magnet on a first side of a feedpath and b) a second magnet between the first and third magnets on a second opposite side of the feedpath, wherein the first and third magnets have a same polarity and wherein the second magnet has a complementary polarity to the first and third magnets. Alternatively and as shown in FIG. 5 of EP 2 157 141 A1, the first magnetic-field-generating device may further comprise a fourth magnets on the same side of the feedpath as the second magnet, having the polarity of the second magnet and complementary to the polarity of the third magnet. As described in EP 2 157 141 A1, the magnetic-field-generating device can be either underneath the coating comprising the platelet-shaped magnetic or magnetizable pigment particles, or above and underneath. Alternatively, the magnetic-field-generating device may comprises an arrangement of rollers as shown in FIG. 9 of EP 2 157 141 A1, i.e. the magnetic-field-generating device comprises two spaced apart wheels having magnets thereon, the magnets having the same staggered configuration as those described hereabove.

U.S. Pat. No. 4,859,495 discloses a magnetic-field-generating device comprising either two pairs of Helmholtz which are arranged at right angle to each other (FIG. 2), or two conductive plates (FIG. 3) such as, for example, copper plates which are disposed above and below the moving web, each one of the pairs of Helmholtz coils or of the conductive plates being addressed with a current at 90° out-of-phase with the current addressed to the other pair of Helmholtz coils or to the other conductive plate, this causing a rotating magnetic field having no vertical component and only components in the plane of the web. Said rotating magnetic field forces the magnetic particles of the paint composition to align perpendicularly to the field components, i.e. at a 90° angle with the web. By extension, the magnetic-field-generating device disclosed in U.S. Pat. No. 4,859,495 may be used to align magnetic particles in any given direction, by providing magnetic field components that lie only in plane perpendicular to said given direction.

Alternative magnetic-field-generating devices for bi-axially orienting at least part of the platelet-shaped magnetic or magnetizable pigment particles of the second pattern are of linear permanent magnet Halbach arrays, i.e. assemblies comprising a plurality of magnets with different magnetization directions. Detailed description of Halbach permanent magnets was given by Z. Q. Zhu and D. Howe (Halbach permanent magnet machines and applications: a review, IEE. Proc. Electric Power Appl., 2001, 148, p. 299-308). The magnetic field produced by such a Halbach array has the properties that it is concentrated on one side while being weakened almost to zero on the other side. Typically, linear permanent magnet Halbach arrays comprise one or more non-magnetic blocks made for example of wood or plastic, in particular plastics known to exhibit good self-lubricating properties and wear resistance such as polyacetal (also called polyoxymethylene, POM) resins, and magnets such as Neodymium-Iron-Boron (NdFeB) magnets.

Alternative magnetic-field-generating devices for bi-axially orienting at least part of the platelet-shaped magnetic or magnetizable pigment particles of the second pattern are spinning magnets, said magnets comprising disc-shaped spinning magnets or magnet assemblies that are essentially magnetized along their diameter. Suitable spinning magnets or magnet assemblies are described in US 2007/0172261, said spinning magnets or magnet assemblies generate radially symmetrical time-variable magnetic fields, allowing the bi-orientation of platelet-shaped magnetic or magnetizable pigment particles of a not yet cured coating composition. These magnets or magnet assemblies are driven by a shaft (or spindle) connected to an external motor. Alternatively, said magnets or magnet assemblies are shaft-free disc-shaped spinning magnets or magnet assemblies constrained in a housing made of non-magnetic, preferably non-conducting, materials and are driven by one or more magnet-wire coils wound around the housing. Optionally, one or more Hall-effect elements are placed along the housing such that they are able to detect the magnetic field generated by the spinning magnet or magnet assembly and to appropriately address the one or more magnet-wire coils with electric current. Such spinning magnets or magnet assemblies simultaneously serve as the rotor of an electric motor and as orientation mean for platelet-shaped magnetic of magnetizable pigment particles of a not yet cured coating composition. In this way, it is possible to limit the driving mechanism of the device to the strictly necessary parts and to strongly reduce its size. The magnetic-field-generating device can be either underneath the layer comprising the platelet-shaped magnetic or magnetizable pigment particles or aside said layer. Detailed description of such devices is given in the co-pending European patent application 13 195 717.7.

As mentioned hereabove, the curing unit used under step b) comprises a photomask such that the second pattern is not exposed to irradiation. In one embodiment depicted in FIG. 11A, the curing unit (16) is equipped with a stationary screen photomask (18a), which allows for a selective curing of the radiation curable coating composition (12) at one or more predetermined locations of said radiation curable composition (12) as described hereabove. When the radiation curable coating composition leaves the Halbach cylinder assembly (9), the one or more predetermined locations of said coating composition that have not been exposed to irradiation by the curing unit (16) comprises platelet-shaped magnetic or magnetizable pigment particles in a non-fixed or non-frozen oriented state. The platelet-shaped magnetic or magnetizable pigment particles may therefore be oriented and fixed or frozen in a subsequent orienting step provided by a further magnetic-field-generating device and curing unit placed downstream to the Halbach cylinder assembly.

In another embodiment depicted in FIG. 11B, the curing unit (16) is equipped with a moving screen photomask (18b), which preferably moves in synchronicity with the radiation curable coating composition (12) through the Halbach cylinder assembly (9). Such moving screen photomask (18b) allows for a more precise and more complete selective curing of the radiation curable coating composition at one or more predetermined locations of the radiation curable coating composition (12), since it follows said coating composition (12) in a relative stationary position under the curing unit (16). In this arrangement, said moving screen photomask (18b) may be embodied as a belt which rotates such as to stay in synchronicity with the radiation curable coating composition (12) moving through the Halbach cylinder assembly (9). Optionally, the moving screen photomask (18b) may be embodied as a flexible closed belt.

In another embodiment depicted in FIG. 11C, the curing unit (16) and the moving screen photomask (18b) are placed opposite to the radiation curable coating composition (12) on the other side of the substrate (11), and the curing step is performed through the substrate (11), provided that said substrate (11) is transparent enough, as explained hereabove. In such an arrangement, the moving screen photomask (18b) may be embodied as a belt that at the same time supports the substrate (11) through the Halbach cylinder assembly (9). This has the advantage that the moving screen photomask (18b) is very close to the radiation curable coating composition (12), the distance between said moving photomask (18b) and said radiation curing coating composition (12) merely being the thickness of the substrate (11). This results in a particularly precise selective curing of the radiation curable coating composition at one or more predetermined locations. As explained hereabove, when leaving the Halbach cylinder assembly, the radiation curable coating composition still contain platelet-shaped magnetic or magnetizable pigment particles in an non-fixed or non-frozen oriented state, that may be oriented following a desired orientation pattern in a subsequent exposure to the magnetic field of a magnetic-field-generating device magnetic orientation step and fixed or frozen in their orientation and position in a subsequent curing step, downstream to the Halbach cylinder assembly.

Also described herein are devices for producing an OEL such as those described herein on the substrate described herein, said OEL comprising the platelet-shaped magnetic or magnetizable pigment particles being bi-axially oriented in the cured radiation curable coating composition such as described herein, said device comprising a) the Halbach cylinder assembly such as those described herein and b) a curing unit such as those described herein.

The device described herein preferably comprises at least a feeding unit that feeds the substrate described herein under the form of a web or sheets. The device described herein preferably comprises a substrate supporting element and/or a substrate guiding element such as for example rollers or equivalent supporting means to support the substrate. The substrate may be fed either continuously or discontinuously, depending on the printing equipment being used.

Should the OEL described herein be made of a single radiation curable composition such as those described herein and comprising a motif made of a first pattern and a second pattern which is adjacent to the first pattern as described herein, the device described herein comprises a curing unit comprising a photomask such as those described herein. Said photomask is under the form of a fixed screen photomask or a moving screen photomask, as described hereabove. In such a case, the device described further comprises, downstream to the Halbach cylinder assembly, a second orientation unit and a second curing unit. Optionally, a third curing unit may be placed downstream to the second curing unit, to complete curing.

As previously mentioned, the radiation curable composition is preferably applied by a printing process preferably selected from the group consisting of screen printing, rotogravure printing, flexography printing, inkjet printing and intaglio printing (also referred in the art as engraved copper plate printing and engraved steel die printing), more preferably selected from the group consisting of screen printing, rotogravure printing and flexography printing. Accordingly, the device described herein preferably comprises a printing unit, preferably a screen printing unit, a rotogravure printing unit, a flexography printing unit, an inkjet printing unit or an intaglio printing unit and more preferably a screen printing unit, a rotogravure printing unit or a flexography printing unit. The substrate may be fed to the printing unit either continuously (as for example in a rotary screen printing unit) or discontinuously (as for example in a flat-bed screen printing unit).

With the aim of increasing the durability through soiling or chemical resistance and cleanliness and thus the circulation lifetime of an article, a security document or a decorative element or object comprising the OEL described herein, or with the aim of modifying their aesthetical appearance (e.g. optical gloss), one or more protective layers may be applied on top of the OEL. When present, the one or more protective layers are typically made of protective varnishes. These may be transparent or slightly colored or tinted and may be more or less glossy. Protective varnishes may be radiation curable compositions, thermal drying compositions or any combination thereof. Preferably, the one or more protective layers are radiation curable compositions, more preferable UV-Vis curable compositions. The protective layers may be applied after the formation of the OEL.

The OEL described herein may be provided directly on a substrate on which it shall remain permanently (such as for banknote applications). Alternatively, an OEL may also be provided on a temporary substrate for production purposes, from which the OEL is subsequently removed. This may for example facilitate the production of the OEL, particularly while the binder material is still in its fluid state. Thereafter, the temporary substrate may be removed from the OEL. Of course, in such cases the radiation curable coating composition must be in a form that is physically integral after the curing step. Thereby, a film-like transparent and/or translucent material consisting of the OEL as such (i.e. essentially consisting of oriented platelet-shaped magnetic or magnetizable pigment particles, cured binder for fixing the pigment particles in their orientation and forming a film-like material, such as a plastic film, and further optional components) can be provided.

Alternatively, an adhesive layer may be present on the OEL or may be present on the substrate comprising an OEL, said adhesive layer being on the side of the substrate opposite the side where the OEL is provided or on the same side as the OEL and on top of the OEL. Therefore an adhesive layer may be applied to the OEL or to the substrate. In such instances, an adhesive label comprising the adhesive layer and the OEL or an adhesive layer, the OEL and the substrate as the case may be formed. Such a label may be attached to all kinds of documents or other articles or items without printing or other processes involving machinery and rather high effort.

Also described herein are articles, in particular security documents, decorative elements or objects, comprising the OEL produced according to the present invention. The articles, in particular security documents, decorative elements or objects, may comprise more than one (for example two, three, etc.) OELs produced according to the present invention. For example, the article, in particular security document or the decorative element or object, may comprise a first OEL and a second OEL, wherein both of them are present on the same side of the substrate or wherein one is present on one side of the substrate and the other one is present on the other side of the substrate. If provided on the same side of the substrate, the first and the second OELs may be adjacent or not adjacent to each other. Additionally or alternatively, one of the OELs may partially or fully superimpose the other OEL.

As mentioned hereabove, the OELs produced according to the present invention may be used for decorative purposes as well as for protecting and authenticating a security document. Typical examples of decorative elements or objects include without limitation luxury goods, cosmetic packaging, automotive parts, electronic/electrical appliances, furniture and fingernail lacquers

Security documents include without limitation value documents and value commercial goods. Typical example of value documents include without limitation banknotes, deeds, tickets, checks, vouchers, fiscal stamps and tax labels, agreements and the like, identity documents such as passports, identity cards, visas, driving licenses, bank cards, credit cards, transactions cards, access documents or cards, entrance tickets, public transportation tickets or titles and the like, preferably banknotes, identity documents, right-conferring documents, driving licenses and credit cards. The term “value commercial good” refers to packaging materials, in particular for cosmetic articles, nutraceutical articles, pharmaceutical articles, alcohols, tobacco articles, beverages or foodstuffs, electrical/electronics articles, fabrics or jewelry, i.e. articles that shall be protected against counterfeiting and/or illegal reproduction in order to warrant the content of the packaging like for instance genuine drugs. Examples of these packaging materials include without limitation labels, such as authentication brand labels, tamper evidence labels and seals. It is pointed out that the disclosed substrates, value documents and value commercial goods are given exclusively for exemplifying purposes, without restricting the scope of the invention. Alternatively, the OEL may be produced onto an auxiliary substrate such as for example a security thread, security stripe, a foil, a decal, a window or a label and consequently transferred to a security document in a separate step. The skilled person can envisage several modifications to the specific embodiments described above without departing from the spirit of the present invention. Such modifications are encompassed by the present invention.

Further, all documents referred to throughout this specification are hereby incorporated by reference in their entirety as set forth in full herein.

The present invention will now be described by way of Examples, which are however not intended to limit its scope in any way.

### EXAMPLE

The example has been carried out by using the UV-curable screen printing coating composition of the formula given in Table 1 below.

TABLE 1

| | |
|---|---|
| Epoxyacrylate oligomer | 28% |
| Trimethylolpropane triacrylate monomer | 19.5% |
| Tripropyleneglycol diacrylate monomer | 20% |
| Genorad 16 (Rahn) | 1% |
| Aerosil 200 ® (Evonik) | 1% |
| Speedcure TPO-L (Lambson) | 2% |
| Irgacure ® 500 (BASF) | 6% |
| Genocure EPD (Rahn) | 2% |
| BYK ®-371 (BYK) | 2% |
| Tego Foamex N (Evonik) | 2% |
| platelet-shaped 7-layer optically variable | 16.5% |
| magnetic pigment particles (*) | |

(*) gold-to-green optically variable magnetic pigment particles having a diameter of 19 μm and a thickness of about 1 μm, obtained from JDS-Uniphase, Santa Rosa, CA.

A Halbach cylinder assembly depicted in FIG. 13 was used to orient the platelet-shaped magnetic pigment particles in the UV-curable screen printing coating composition described in Table 1. Said Halbach cylinder assembly comprised:
i) a holder (19) made of POM (polyoxymethylene) having the dimensions 115×90×10 mm;
ii) a back plate (20) made of POM, being glued perpendicularly to the holder (19) and having the dimensions 70×70×10 mm;
iii) four structures, each one comprising a magnet bar and a magnet-wire coil around said magnet bar, the four structures being arranged on a 40×40 mm square, the individual magnetization directions of the magnet bars being disposed such as to build a Halbach cylinder assembly; each structure comprising:
   a) a magnet-wire coil (21) having 450 turns of a 0.5 mm lacquer-insulated copper wire fixed on
   b) a 20 mm diameter/40 mm long coil support (22) made of POM,
   c) a magnet bar (23) made of Nd₂Fe₁₄B and having the dimensions 3×5×64 mm, with transverse magnetization, i.e. having their N→S direction along the short (3 mm) axis, and
   d) two iron pole pieces (24) made of pure iron (supplied by ARMCO), having the dimensions 1×5×64 mm, and being glued onto the N and S poles of the magnet bar (23), while being mechanically holding them in a centered position;
iv) a substrate holder (25) of dimensions 115×70×2 mm, said holder being disposed such as to run through the center of said Halbach cylinder assembly, in a mirror plane between each two pairs of structures.

The magnet bars (23) have a magnetization direction perpendicular to the substrate holder (25), their South pole being indicated in black and their North pole in light grey. The resulting magnetic dipole field H_{xy} lies in the plane of the substrate holder (25).

The magnetic field H_{xy} generated by the magnet bars (23) of the structures was measured with a calibrated Hall probe at the center of the substrate holder (25) and amounted to 18 mT in x-direction, and to zero in the hereto orthogonal directions (y and z). After application of a 1 A DC current of the same direction to the four magnet-wire coils (21) of the structures, an additional dynamic z-component H_{z} to the magnetic field of 5.4 mT was measured at the center of the substrate holder (25). Hence, applying an AC current of 3 A peak-to-peak to the four magnet-wire coils produced a dynamic magnetic field in the z-direction (H_{z}), which was of similar strength as the stationary magnetic field in the x-direction (H_{xy}), and hence resulted in an oscillatory movement of the platelet-shaped magnetic pigment particles of about ±45°.

A drop of the UV-curable screen printing coating composition described in Table 1 was applied onto a microscopy slide and mechanically spread out over a surface of about 2 cm². An image of the resulting surface of the coating composition was taken using an enlarging telecentric lens with on-axis illumination. Since the resolution of the imaging system was 3.5 μm per pixel, i.e. better than the mean diameter of the platelet-shaped magnetic or magnetizable pigment particles, i.e. about 19 μm, the individual platelet-shaped magnetic or magnetizable pigment particles were visible in the image.

The telecentric lens had a very narrow acceptance angle, about ±1° with respect to its optical axis. Only light entering under this narrow angle contributed to the image. Due to the on-axis illumination condition, only platelet-shaped magnetic pigment particles with a surface orthogonal to the optical axis of the telecentric lens visible.

FIG. 14A shows the image of the UV-curable screen printing coating composition, as spread out on the microscopy slide. Only very few platelet-shaped magnetic pigment particles were in reflecting condition.

Using the equipment of FIG. 13, the microscopy slide carrying the UV-curable screen printing coating composition was then introduced along the substrate holder (25) into the center of the Halbach cylinder assembly. The platelet-shaped magnetic pigment particles in the coating composition oriented themselves in the magnetic field H_{xy} of the Halbach cylinder assembly, as shown by a considerable increase of its brilliance. An image of the surface of the UV-curable screen printing coating composition was taken again with the telecentric lens under on-axis illumination.

FIG. 14B shows the image of the so-obtained mono-axially oriented platelet-shaped magnetic pigment particles in UV-curable screen printing coating composition; there were more pigment particles in reflecting condition than in the native coating composition (FIG. 14A).

A 50 Hz AC current of 10 A was then applied to the four magnet-wire coils (21) switched in parallel, i.e. a current of 2.5 A per magnet-wire coil. The UV-curable screen printing coating composition strongly increased in brilliance and an image of the coating composition was taken again with the telecentric lens under on-axis illumination. FIG. 14C shows the image of the bi-axially oriented platelet-shaped magnetic or magnetizable pigment particles in the UV-curable screen printing coating composition; there were considerably more pigment particles in reflecting condition in FIG. 14C than in FIGS. 14A and 14B.

1. A process for producing an optical effect layer (OEL) on a substrate, said process comprising the steps of:
a) applying on a substrate surface a radiation curable coating composition comprising
i) platelet-shaped magnetic or magnetizable pigment particles and ii) a binder, said radiation curable composition being in a first state,
b) exposing the radiation curable coating composition to a dynamic magnetic field of a magnetic assembly comprising a Halbach cylinder assembly comprising
either i) three or more magnet bars and a single magnet-wire coil surrounding said assembly, or ii) three or more magnet bars, a pole piece encompassing said assembly and comprising two poles facing said assembly, each pole being surrounded by a magnet-wire coil, or iii) three or more structures, each of said three or more structures comprising a magnet bar and a magnet-wire coil surrounding said magnet bar, so as to bi-axially orient at least a part of the platelet-shaped magnetic or magnetizable pigment particles, said three or more magnet bars being transversally magnetized, and
c) at least partially curing the radiation curable coating composition of step b) to a second state so as to fix the platelet-shaped magnetic or magnetizable pigment particles in their adopted positions and orientations, said step c) being carried out partially simultaneously or simultaneously with step b).

2. The process according to claim 1, wherein step b) is carried out so as to bi-axially orient at least a part of the platelet-shaped magnetic or magnetizable pigment particles to i) have their major and minor axes substantially parallel to the substrate surface, or ii) have their major axis at a substantially non-zero elevation angle to the substrate surface and their minor axis substantially parallel to the substrate surface.

3. The process according to claim 1, wherein the applying step a) is carried out by a printing process selected from the group consisting of screen printing, rotogravure printing, flexography printing and intaglio printing.

4. The process according to claim 1, wherein the dynamic magnetic field used in step b) results from a magnetic dipole field (H_{xy}) inside the Halbach cylinder assembly and a dynamic-component (H_{z}) obtained by applying an AC current of appropriate amplitude and frequency to the magnet-wire coil(s).

5. The process according to claim 1, wherein step c) is carried out by UV-Vis light radiation curing.

6. The process according to claim 1, wherein at least a part of the platelet-shaped magnetic or magnetizable pigment particles is constituted by platelet-shaped optically variable magnetic or magnetizable pigment particles.

7. The process according to claim 6, wherein the platelet-shaped optically variable magnetic or magnetizable pigment particles are selected from the group consisting of platelet-shaped magnetic thin-film interference pigment particles, platelet-shaped magnetic cholesteric liquid crystal pigment particles, platelet-shaped interference coated pigment particles comprising a magnetic material and mixtures of two or more thereof.

8. The process according to claim 1, wherein at least a part of the platelet-shaped magnetic or magnetizable pigment particles comprises a magnetic metal selected from the group consisting of cobalt (Co), iron (Fe), gadolinium (Gd) and nickel (Ni); magnetic alloys of iron, manganese, cobalt, nickel and mixtures of two or more thereof magnetic oxides of chromium, manganese, cobalt, iron, nickel and mixtures of two or more thereof and mixtures of two or more thereof.

9. The process according to claim 1 wherein the OEL comprises a motif made of a first pattern and a second pattern which is adjacent to the first pattern, said motif being made of the radiation curable coating composition,
wherein the at least partially curing step c) is carried out with a curing unit comprising a photomask such that the second pattern is not exposed to irradiation,
wherein said process further comprises a step d) of exposing the motif made of the radiation curable coating composition of step c), wherein the second pattern is in a first state due to the presence of the photomask under step c), to the magnetic field of a magnetic-field-generating device thereby orienting at least part of the platelet-shaped magnetic or magnetizable pigment particles of the second pattern so as to follow an orientation which is different from the orientation of the platelet-shaped magnetic or magnetizable pigment particles of the first pattern and follow any orientation except a random orientation, and
wherein said process further comprises a step e) of simultaneously, partially simultaneously or subsequently curing the radiation curable composition to a second state so as to fix the platelet-shaped magnetic or magnetizable pigment particles in their adopted positions and orientations.

10. An optical effect layer (OEL) produced by the process recited in claim 1.

11. A security document or a decorative element or object comprising one or more optical effect layer (OEL) recited in claim 10.

12. A device for producing an optical effect layer (OEL) on a substrate, said OEL comprising platelet-shaped magnetic or magnetizable pigment particles being bi-axially oriented in a cured radiation curable coating composition, the device comprising:
a) a Halbach cylinder assembly comprising either i) three or more magnet bars and a single magnet-wire coil surrounding said assembly, or ii) three or more magnet bars, a pole piece encompassing said assembly and comprising two poles facing said assembly, each pole being surrounded by a magnet-wire coil, or iii) three or more structures, each of said three or more structures comprising a magnet bar and a magnet-wire coil surrounding said magnet bar, so as to bi-axially orient at least a part of the platelet-shaped magnetic or magnetizable pigment particles, said at least three magnet bars being transversally magnetized, and
b) a curing unit.

13. The device according to claim 12, wherein the curing unit comprises a photomask.

14. The device according to claim 12, further comprising a substrate supporting element and/or a substrate guiding element.

15. The device according to claim 12, further comprising a printing unit, preferably a screen printing unit, a rotogravure printing unit, a flexography printing unit or an intaglio printing unit.
